(19) United States
(12) Patent Application Publication
(10) Pub. No.: US 2015/0269643 A1
(43) Pub. Date: Sep. 24, 2015

(54) SYSTEMS, ARTICLES AND METHODS RELATED TO RETAIL FRAMED IMAGE ORDERING AND FULFILLMENT, EMPLOYING WIRELESS COMMUNICATIONS

(71) Applicant: INDUSTRIAL GENEROSITY INC., Seattle, WA (US)

(72) Inventors: Thomas Steven Riley, Seattle, WA (US); Diana Jo Schwend, Seattle, WA (US); Christopher Warren Bryant, Seattle, WA (US); Steven Joseph Dodd, Sammamish, WA (US)

(21) Appl. No.: 14/666,033

(22) Filed: Mar. 23, 2015

Related U.S. Application Data
(60) Provisional application No. 61/969,665, filed on Mar. 24, 2014.

(51) Int. Cl. G06Q 30/06; H04N 1/00; G06F 3/0484; G06F 3/0481; G06F 3/0482

(52) U.S. Cl. CPC G06Q 30/0621; G06F 3/04817; G06F 3/0482; G06F 3/04842; H04N 1/00145; H04N 1/00183; H04N 1/00167; H04N 1/00177; G06Q 30/0643

(57) ABSTRACT

An order placement and fulfillment system and method allows orders to be automatically placed for framed prints, using a user's own images. The system and method provide for a streamlined set of options to select for, accommodating small screens commonly associated with mobile devices.

### BACKGROUND

1. Technical Field

The present disclosure generally relates to ordering and fulfillment for personalized objects, and in particular relates to ordering and fulfillment via mobile devices.

2. Description of the Related Art

Mobile devices, for example smartphones and tablet computers, are ubiquitous. These mobile devices typically include communications capabilities, for instance via cellular service (e.g., EDGE, G3, G4, LTE, SMS), or wireless services (e.g., Wi-Fi®, Bluetooth®), thus can be denominated as mobile communications devices even when their primary function is not communications.

As newer models are introduced, many of these mobile communications devices include increasingly higher resolution image capture devices (e.g., cameras). These image capture devices are typically capable of capturing digital still and/or digital video images. Mobile communications devices are to a large extent replacing more traditional dedicated or single purpose devices such as digital cameras and/or handheld video cameras. This is likely due to the convenience of capturing still or video images using a mobile communications device, which many individuals routinely carry as their primary means of wireless communications (e.g., phone, electronic mail/email, texts or SMS messages).

The days of having film processed and photographs printed are, for most people, in the past. Many people use home printers, such as ink jet printers, to print copies of the images they capture with their mobile communications device. A person may use a commercial printer, which may be located at some retail location, when a higher resolution of printing and/or media is desired. For some of the best or most treasured printed pictures, a person will go to a retail location to purchase a frame. This approach can be time consuming and expensive. For example, this approach may require an individual to locate a suitably high grade printer with high quality media stock and to pick a suitable frame. Such may require the user to select the picture to be printed ahead of time, to avoid creating a long line or queue at the printer. Such may require the user to cut the resulting print of the picture to fit the frame, and possibly obtain a mat if the individual prefers that the printed picture be matted in the frame.

A new approach to ordering and fulfillment is desirable.

### BRIEF SUMMARY

Systems, methods and articles may allow individuals to automatically place orders via their mobile communications devices for framed prints of images without having to locate and visit a retail location, and without having to wait in line. The systems, methods and articles may advantageously employ mobile communications devices and an intelligent user interface (UI) to provide to an efficient way to wirelessly place orders for framed images. The intelligent UI allows implementation on relatively small screens associated with mobile communications devices, and also greatly simplifies the number of choices and hence user inputs required to order a custom framed image. A back-office system receives orders and facilitates fulfillment.

A method of operation in a processor-based system may be summarized as including: receiving an orientation selection by at least one processor, the orientation selection which corresponds to a choice of a respective orientation for a tangible frame to be ordered; receiving a frame type selection by at least one processor, the frame type selection which corresponds to a choice of a type of the tangible frame to be ordered; determining a set of selectable sizes of the tangible frame to be ordered by at least one processor, the determination based at least in part on the orientation selection and the frame type selection; providing a set of size options corresponding to the determined set of selectable sizes, by at least one processor, the selection of which corresponds to a choice of a respective size for the tangible frame to be ordered; and generating a virtual representation of the tangible frame with a selected image framed thereby by at least one processor.

The method may further include: receiving an image selection by at least one processor, the image selection indicative of a selection of the selected image before determining the set of selectable sizes of the tangible frame to be ordered. Determining a set of selectable sizes of the tangible frame to be ordered based at least in part on the orientation selection and the frame type selection may include determining the set of selectable sizes of the tangible frame to be ordered based at least in part on the orientation selection and the frame type selection, and a set of image information that specifies one or more characteristics of an image file that stores a representation of the selected image. The selected image may be a picture, and the one or more characteristics may include a pixel density of an image file which represents the selected image. The method may further include: providing a set of user selectable size icons based on the determined set of selectable sizes of the tangible frame to be ordered. The providing the set of user selectable size icons may be in response to receiving the frame type selection. The method may further include: providing a set of user selectable orientation icons via at least one user input/output device, selection of which corresponds to the choice of the respective orientation for the tangible frame; and providing a set of user selectable frame type icons, selection of which corresponds to the choice of a type of tangible frame. Providing a set of user selectable orientation icons via at least one user input/output device may include providing a portrait icon which corresponds to the choice of a portrait orientation for the tangible frame; and providing a landscape icon which corresponds to the choice of a landscape orientation for the tangible frame. Providing a set of user selectable orientation icons via at least one user input/output device may further include providing a square icon which corresponds to the choice of a square orientation for the tangible frame. Providing a set of user selectable frame type icons, selection of which corresponds to the choice of a type of tangible frame may include providing a wall frame icon which corresponds to a wall mounted tangible frame and a desk frame icon that corresponds to a desk mounted tangible frame. The method may further include: receiving a frame color selection by at least one processor, the frame color selection which corresponds to a choice of a respective frame color for the tangible frame to be ordered. The method may further include: providing a set of user selectable frame color icons, selection of which corresponds to a choice of a respective frame color of the tangible frame to be ordered. The method may further include: receiving a mat selection by at least one processor, the mat selection which corresponds to a choice of a respective mat option for the tangible frame to be ordered. The method may further include: providing a set of user selectable mat option icons, selection of which corresponds to a choice of a respective mat option for the tangible frame to be ordered. The method may further include: determining based on the received frame type selection whether to provide a set of user selectable mat option icons by at least one processor, selection of which corresponds to a choice of a respective mat option for the tangible frame to be ordered. The method may further include: receiving shipping information by at least one processor; receiving billing information by at least one processor; receiving gift information if a gift option is selected, the gift information including a gift message; and generating an order for the tangible frame. Generating a virtual representation of the tangible frame with a selected image framed thereby may include generating a virtual perspective image in which a leg of the tangible frame is visible if the frame type selection corresponds to the desk mounted tangible frame and with a mat if a mat selection corresponds to include a mat. Receiving an orientation selection, receiving a frame type selection, determining a set of selectable sizes of the tangible frame to be ordered, providing a set of size options, and generating a virtual representation of the tangible frame with a selected image framed thereby may each be performed by at least one processor of a mobile communications device having at least one image sensor to capture images and at least one non-transitory processor-readable medium communicatively coupled to the at least one processor and the at least one image sensor.

A processor-based system may be summarized as including: at least one processor; and at least one nontransitory processor-readable medium, communicatively coupled to the at least one processor and which stores at least one of processor-executable instructions or data, wherein in use the at least one processor: receives an orientation selection, the orientation selection which corresponds to a choice of a respective orientation for a tangible frame to be ordered; receives a frame type selection, the frame type selection which corresponds to a choice of a type of the tangible frame to be ordered; determines a set of selectable sizes of the tangible frame to be ordered by at least one processor, the determination based at least in part on the orientation selection and the frame type selection; causes provision of a set of size options corresponding to the determined set of selectable sizes, the selection of which corresponds to a choice of a respective size for the tangible frame to be ordered; and generates a virtual representation of the tangible frame with a selected image framed thereby.

The at least one processor may further: receive an image selection, the image selection indicative of a selection of the selected image before the at least one processor determines the set of selectable sizes of the tangible frame to be ordered. To determine a set of selectable sizes of the tangible frame to be ordered the at least one processor may determine the set of selectable sizes of the tangible frame to be ordered based at least in part on the orientation selection and the frame type selection, and a set of image information that specifies one or more characteristics of an image file that stores a representation of the selected image. The selected image may be a picture, and the one or more characteristics may include a pixel density of an image file which represents the selected image. The at least one processor may further: provide a set of user selectable size icons based on the determined set of selectable sizes of the tangible frame to be ordered. The at least one processor may further: provide the set of user selectable size icons in response to receipt of the frame type selection. The at least one processor may further: provide a set of user selectable orientation icons via at least one user input/output device, selection of which corresponds to the choice of the respective orientation for the tangible frame; and may provide a set of user selectable frame type icons, selection of which corresponds to the choice of a type of tangible frame. To provide a set of user selectable orientation icons via at least one user input/output device the at least one processor may further: provide a portrait icon which corresponds to the choice of a portrait orientation for the tangible frame; and may provide a landscape icon which corresponds to the choice of a landscape orientation for the tangible frame. To provide a set of user selectable orientation icons via at least one user input/output device the at least one processor may further: provide a square icon which corresponds to the choice of a square orientation for the tangible frame. To provide a set of user selectable frame type icons, selection of which corresponds to the choice of a type of tangible frame the at least one processor: may provide a wall frame icon which corresponds to a wall mounted tangible frame and a desk frame icon that corresponds to a desk mounted tangible frame. The at least one processor may further: receive a frame color selection by at least one processor, the frame color selection which corresponds to a choice of a respective frame color for the tangible frame to be ordered. The at least one processor may further: provide a set of user selectable frame color icons, selection of which corresponds to a choice of a respective frame color of the tangible frame to be ordered. The at least one processor may further: receive a mat selection by at least one processor, the mat selection which corresponds to a choice of a respective mat option for the tangible frame to be ordered. The at least one processor may further: provide a set of user selectable mat option icons, selection of which corresponds to a choice of a respective mat option for the tangible frame to be ordered. The at least one processor may further: determine based on the received frame type selection whether to provide a set of user selectable mat option icons by at least one processor, selection of which corresponds to a choice of a respective mat option for the tangible frame to be ordered. The at least one processor may further: receive shipping information by at least one processor; receive billing information by at least one processor; receive gift information if a gift option is selected, the gift information including a gift message; and generate an order for the tangible frame. To generate a virtual representation of the tangible frame with a selected image framed thereby the at least one processor: may generate a virtual perspective image in which a leg of the tangible frame is visible if the frame type selection corresponds to the desk mounted tangible frame and with a mat if a mat selection corresponds to include a mat. The processor-based system may be in the form of a mobile communications device having at least one image sensor to capture images and at least one touch sensitive display user input/output device.

A method of operation in a processor-based system may be summarized as including: receiving an image selection by at least one processor, the image selection indicative of a selection of an image to be framed in a tangible frame; determining a subset of framing options from a plurality set [plurality of sets? (global)] of framing options by at least one processor, based at least in part on a set of image information that specifies one or more characteristics of an image file that stores a representation of the selected image; causing the determined subset of framing options to be presented; receiving by at least one processor at least one selection that corresponds to at least one of the presented framing options; and generating by at least one processor a virtual representation of the tangible frame based on the received at least one selection with the selected image framed thereby.

The determining a subset of framing options from a plurality set of framing options based at least in part on a set of image information that specifies one or more characteristics of an image file may include determining a set of size options corresponding to the determined set of selectable sizes, by at least one processor, the selection of which corresponds to a choice of a respective size for the tangible frame to be ordered. The method may further include: receiving an orientation selection by at least one processor, the orientation selection which corresponds to a choice of a respective orientation for a tangible frame to be ordered; and receiving a frame type selection by at least one processor, the frame type selection which corresponds to a choice of a type of the tangible frame to be ordered. Determining a set of size options corresponding to the determined set of selectable sizes may include determining the set of size options based at least in part on the orientation selection and the frame type selection. A maximum of four framing options may be provided to a user at each respective one of a plurality of screens. The method may further include: providing a maximum of four framing options at each respective one of a plurality of framing options screens. Providing a maximum of four framing options at each respective one of a plurality of framing options screens may include: providing an orientation selection screen; providing a frame type selection screen; and providing a size selection screen. Providing a maximum of four framing options at each respective one of a plurality of framing options screens, may further include: providing a frame color screen. Providing a maximum of four framing options at each respective one of a plurality of framing options screens, may further include: providing a mat option selection screen. Providing a maximum of four framing options at each respective one of a plurality of framing options screens, may further include: providing a cropping and positioning screen. The method may further include: providing an image selection screen which includes options for selecting an image from a number of previously captured images and capturing a new image. The method may further include: providing a delivery information screen; and providing a billing information screen.

A processor-based system may be summarized as including: at least one processor; and at least one nontransitory processor-readable medium, communicatively coupled to the at least one processor and which stores at least one of processor-executable instructions or data, wherein in use the at least one processor: receives an image selection, the image selection indicative of a selection of an image to be framed in a tangible frame; determines a subset of framing options from a plurality set of framing options, based at least in part on a set of image information that specifies one or more characteristics of an image file that stores a representation of the selected image; causes the determined subset of framing options to be presented; receives at least one selection that corresponds to at least one of the presented framing options; and generates a virtual representation of the tangible frame based on the received at least one selection with the selected image framed thereby.

To determine a subset of framing options from a plurality set of framing options the at least one processor may determine a set of size options corresponding to the determined set of selectable sizes, by at least one processor, the selection of which corresponds to a choice of a respective size for the tangible frame to be ordered. The at least one processor may further: receive an orientation selection, the orientation selection which corresponds to a choice of a respective orientation for a tangible frame to be ordered; and may receive a frame type selection, the frame type selection which corresponds to a choice of a type of the tangible frame to be ordered. To determine a set of size options corresponding to the determined set of selectable sizes the at least one processor may determine the set of size options based at least in part on the orientation selection and the frame type selection. The processor-based system wherein a maximum of four framing options may be provided to a user at each respective one of a plurality of screens. The at least one processor may further: cause provision of a maximum of four framing options at each respective one of a plurality of framing options screens. To cause provision of a maximum of four framing options at each respective one of a plurality of framing options screens, the at least one processor may cause provision of: an orientation selection screen; a frame type selection screen; and a size selection screen. To provide a maximum of four framing options at each respective one of a plurality of framing options screens, the at least one processor may cause provision of a frame color screen. To provide a maximum of four framing options at each respective one of a plurality of framing options screens, the at least one processor may cause provision of a mat option selection screen. To provide a maximum of four framing options at each respective one of a plurality of framing options screens, the at least one processor may cause provision of a cropping and positioning screen. The at least one processor may further: cause provision of an image selection screen which includes options for selecting an image from a number of previously captured images and capturing a new image. The at least one processor may further: cause provision of a delivery information screen; and may cause provision of a billing information screen.

A method of operation in a processor-based system may be summarized as including: receiving an image selection by at least one processor, the image selection indicative of a selection of an image to be framed; receiving by at least one processor at least one selection that corresponds to at least one of a plurality of framing options; and generating by at least one processor a virtual representation of a tangible frame based on the received at least one selection with the selected image framed thereby, the virtual representation being a perspective view in which a leg of the tangible frame is visible if a frame type selection corresponds to a desk mounted tangible frame and with a mat if a mat selection corresponds to include a mat.

The method may further include: providing an orientation selection screen with a maximum of four framing options; providing a frame type selection screen with a maximum of four framing options; and providing a size selection screen with a maximum of four framing options. The method may further include: providing a frame color screen with a maximum of four framing options. The method may further include: providing a mat option selection screen with a maximum of four framing options. The method may further include: providing a cropping and positioning screen.

A processor-based system may be summarized as including: at least one processor; and at least one nontransitory processor-readable medium, communicatively coupled to the at least one processor and which stores at least one of processor-executable instructions or data, wherein in use the at least one processor: receives an image selection, the image selection indicative of a selection of an image to be framed; receives at least one selection that corresponds to at least one of a plurality of framing options; and generates a virtual representation of a tangible frame based on the received at least one selection with the selected image framed thereby, the virtual representation being a perspective view in which a leg of the tangible frame is visible if a frame type selection corresponds to a desk mounted tangible frame and with a mat if a mat selection corresponds to include a mat.

The at least one processor may further cause provision of: an orientation selection screen with a maximum of four framing options; a frame type selection screen with a maximum of four framing options; and a size selection screen with a maximum of four framing options. The at least one processor may cause provision of: a frame color screen with a maximum of four framing options. The at least one processor may further cause provision of: a mat option selection screen with a maximum of four framing options. The at least one processor may further cause provision of: a cropping and positioning screen.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic view of an order placement and fulfillment system in which a number of users place orders for custom framed prints via mobile devices, the orders processed, images printed, resulting prints framed and optionally matted per user specifications, and delivered, according to one illustrated embodiment.

FIG. 2 is a functional block diagram of portions of the order placement and fulfillment system of FIG. 1, according to one illustrated embodiment.

FIGS. 3A-3D are a flow diagram showing a method of operation of a processor-based device, for example a mobile communications device, in an order placement and fulfillment system, according to one illustrated embodiment.

FIGS. 4A-4Z, 4AA, 4AB, and 4AC are screen prints of a plurality of screens or windows in a graphical user interface (GUI) provided by a processor-based device for use in the order placement and fulfillment system of FIG. 1, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communications devices (e.g., smartphones, tablet computers, personal digital assistants), server computers, financial debit or credit network systems, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

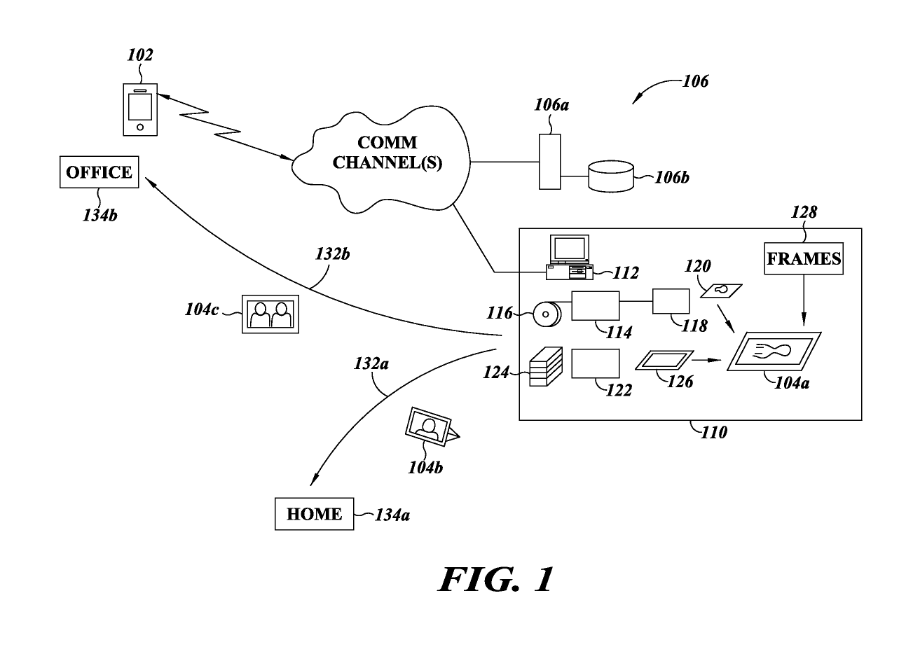

FIG. 1 shows an order placement and fulfillment system 100 for use in ordering custom framed prints of images, according to one illustrated embodiment.

As described in detail herein, the order placement and fulfillment system 100 allows customers or users who carry or bear mobile devices 102 (only one shown) to custom order framed prints 104a, 104b, 104c (collectively 104) of images without needing to go to a physical (i.e., “bricks and mortar”) retail location. The framed prints 104 are tangible objects, which can be delivered to the user, or to others, as explained herein.

As illustrated in FIG. 1, a user or customer uses a mobile device 102 to wirelessly place an order for a framed print 104 with an ordering system 106 via one or more communications channels, for instance communications networks (e.g., LAN, WAN, Internet, Worldwide Web, cellular network) 108.

The mobile device(s) 102 may take any of a large variety of forms. For example, mobile devices 102 may take the form of wireless communications devices, for instance smartphones, tablet computers, personal digital assistants, netbooks, and even laptop computers. Typically, the mobile devices include at least one image capture device, for instance a camera with suitable optics and, optionally a flash or illumination source. The mobile devices also typically include one or more transmitters, receivers, transceivers, collectively denominated herein as radios, which provide wireless communications from the mobile devices. The radios may communicate at any of a variety of frequencies and employing any of a variety of communications protocols, for instance frequencies and protocols used for cellular communications (e.g., CDMA, TDMA, EDGE, G3, G4, LTE, GSM) or wireless local area networks (e.g., Wi-Fi®, IEEE 802.11, WiMAX, IEEE 802.16, VoIP), or wireless peer-to-peer communications (e.g., Bluetooth®).

The ordering system 106 may take the form of one or more server computer systems 106a with associated nontransitory processor- or computer-readable storage media 106b, which may store order information and account information. While illustrated as a single server computer system 106a and associated nontransitory storage media 106b, many implementations may employ two or more server computer systems 106a and/or nontransitory associated processor- or computer-readable storage media 106b. Some implementations may employ separate server computer systems 106a and/or associated nontransitory processor- or computer-readable storage media 106b for processing orders and for handing accounts. In some implementations or instances the nontransitory processor- or computer-readable media 106b may include a database or other data structure which stores one or more of: customer identifiers, customer account identifier, order specifications, customer identity information, financial account information (e.g., credit and/or debit account numbers, expiration dates, security codes), and/or rewards account information, data or statistics.

The ordering system 106 may be operated by, or for, a retailer that sells or otherwise provides custom framed prints. The retailer may also operate, or engage another entity to operate, custom framed print production facilities 110.

The custom framed print production facility may include one or more fulfillment server computer systems 112. The fulfillment server computer system(s) 112 may track orders, work flow, materials and even shipping. The fulfillment server computer system(s) 112 may take the form of a server computer, a personal computer, a workstation computer, or other type of computer system. The fulfillment server computer system 112 may be communicatively coupled to the ordering system 106 via one or more networks, for instance one or more LANs.

The custom framed print production facility 110 may include one or more printers 114, preferably high resolution printers for printing images on high quality print stock material or media 116. The custom framed print production facility 110 may include one or more print cutting machines 118, to cut the printed stock material or media to desired sizes to form the prints 120. The custom framed print production facility 110 may include one or more mat cutting machines 122, to cut the mat stock material or media 124 to desired sizes and bevels to form mats 126. The custom framed print production facility 110 may include one or more supplies 128 of frames and/or frame material from which frames 130 are constructed. The frames and/or frame material may be pre-cut to size, or may be cut on demand. The frames 130, cut prints 120, and optionally mats 126, are assembled into custom framed prints 104a per order specifications. As illustrated in FIG. 1, the custom framed prints 104b, 104c are delivered. For instance, the custom framed prints 104c may be delivered as illustrated by arrow 132a to a location 134a associated with a person who placed the order for the custom framed print, for instance delivered to their home or office. Also for instance, the custom framed prints 104b may be delivered as illustrated by arrow 132b to another location 134b, for instance a home or office of a recipient, where the custom printed frame is a gift.

While generally described below in terms of a user interface generated via instructions executing on a mobile device, in some implementations the ordering system 106 may serve as a front or forward facing customer portal, allowing customers to define one or more orders, each of which specifies particular images or image files, framing specifics including frame characteristics, shipping, billing, and/or gift information that constitute an order. For example, the ordering system 106 may operate as a Web server, serving HTML pages or providing Web services which function as the user interface. Thus, in some implementations, the ordering system 106 serves as a front or forward facing customer portal, providing a user interface, for instance a Web based interface, which allows customers to set up and manage respective customer accounts via various processor-based mobile communications devices 102.

In Web based implementations a Web interface may include various pull-down menus, tabs, user selectable icons, input fields, scroll bars, and dialog boxes, as well as other user interface components. The Web interface may allow a user or customer to create a user or customer account using the mobile device 102. The user or customer may enter their full name, screen name or nickname, address, and/or date of birth. The user or customer may optionally enter financial account information, for instance an account number, expiration date, and validation or security code associated with a charge or debit account. This allows automated charging or debiting on purchase of items, goods or services by the user or customer.

The user or customer account may additionally include mobile device address information (e.g., uniform resource locator or URL, phone number, SIM or international mobile subscriber identifier (IMSI), mobile equipment identifier, MAC address) for one or more processor-based mobile devices 102. Entry into the Web interface to create and/or manage a customer's account information may require entering of a user name and a password by the customer, and verification of the user name and password by the ordering system 106.

The ordering system 106 may be communicatively coupled to one or more financial accounts, network computer systems (not shown) and/or associated databases (not shown) via one or more communications channels 108. The financial accounts network computer systems and/or associated databases may be owned and/or operated by third party financial services organizations (e.g., banks, credit card or debit card companies) or by an entity that owns, runs, or is otherwise associated with the retailer. The ordering system 106 may, in some instances, automatically charge or debit a respective financial account of a customer on receipt of each order placed via the mobile device 102. The user or customer may have provided the required information via the customer account which the customer set up using the Web interface.

The various systems, subsystems, and/or processor-based devices are capable of communications, for example via one or more networks 134 (e.g., Wide Area Networks, Local Area Networks), for instance packet switched communications networks, such as the Internet, Worldwide Web portion of the Internet, extranets, intranets, and/or various other types of telecommunications networks such as cellular phone and data networks, and plain old telephone system (POTS) networks. The type of communications infrastructure should not be considered limiting. The communications network(s) may take any of a large variety of forms, and may include modems (e.g., DSL modem, cable modem), routers, network switches, and/or bridges, etc.

While often illustrated as a single nontransitory computer- or processor-readable storage medium, in many implementations each of the various illustrated nontransitory computer- or processor-readable storage media may constitute a plurality of nontransitory storage media. The plurality of nontransitory storage media may be commonly located at a common location, or distributed at a variety of remote locations. Database(s) may be stored separately from one another on separate computer- or processor-readable storage media or may be stored on the same computer- or processor-readable storage medium as one another. Various computer- or processor-readable storage media may be co-located with the corresponding computer systems, for example, in the same room, building or facility. Alternatively, various computer- or processor-readable storage media may be located remotely from the corresponding computer systems (e.g., server computer systems) for example, in a different facility, city, state or country. Electronic or digital information, files or records or other collections of information may be stored at specific locations in non-transitory computer- or processor-readable media, thus are logically addressable portions of such media, which may or may not be contiguous.

While FIG. 1 illustrates a representative networked environment, typical networked environments may include many additional computer systems and entities. The concepts taught herein may be employed in a similar fashion with more populated networked environments than that illustrated in FIG. 1. For example, there are likely hundreds, if not thousands or even millions of users or customers and mobile devices 102. There may be more than one ordering system 106, for example located in different countries or regions within a country.

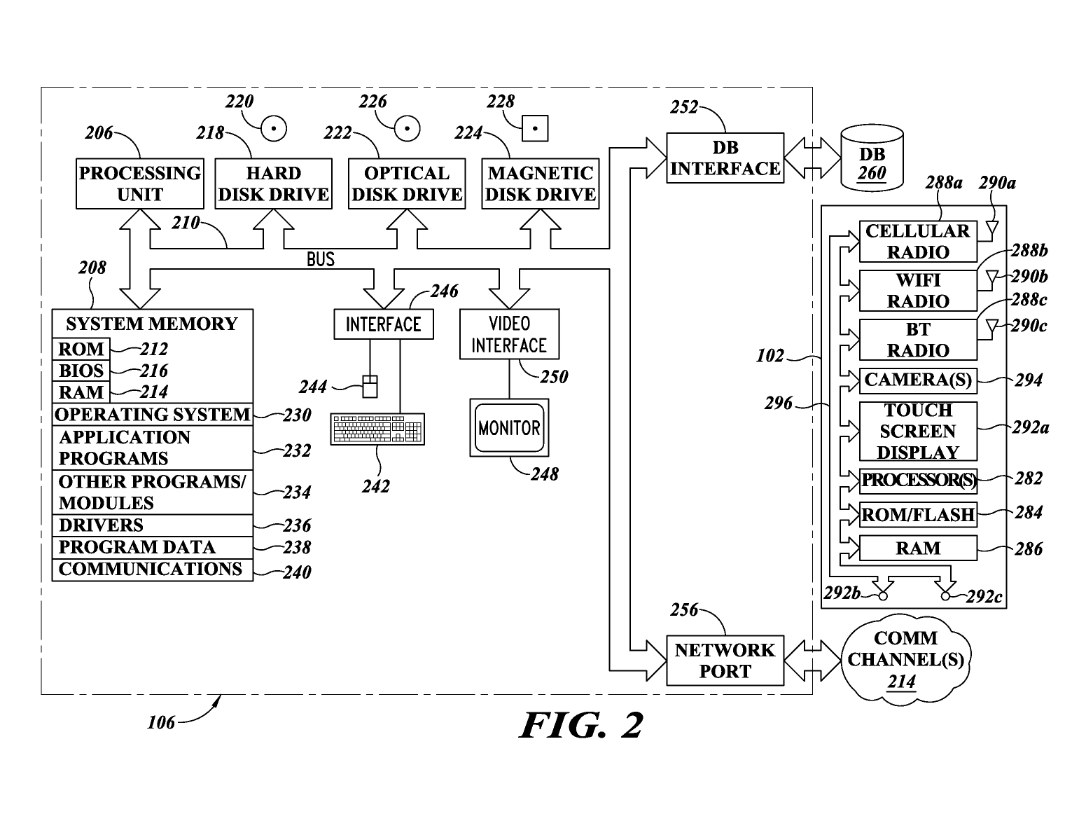

FIG. 2 and the following discussion provide a brief, general description of the components forming an exemplary order placement and fulfillment system 100 including an ordering system 106 and mobile devices 102 (only one shown) in which the various illustrated embodiments can be implemented. The order placement and fulfillment system 100 may, for example, implement the various functions and operations discussed immediately above in reference to FIG. 1. Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices, for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The ordering system 106 may take the form of a conventional PC, server, or other computing system executing logic or other machine-executable instructions. The ordering system 106 includes one or more processors 206, a system memory 208 and a system bus 210 that couples various system components including the system memory 208 to the processor 206. The ordering system 106 will at times be referred to in the singular herein, but this is not intended to limit the embodiments to a single system, since in certain embodiments, there will be more than one ordering system 106 or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processor 206 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which may be incorporated into at least a portion of the ROM 212, contains basic routines that help transfer information between elements within the automated customer interaction system 112, such as during start-up. Some embodiments may employ separate buses for data, instructions and power.

The ordering system 106 also includes a hard disk drive 218 for reading from and writing to a hard disk 220, and an optical disk drive 222 and a magnetic disk drive 224 for reading from and writing to removable optical disks 226 and magnetic disks 228, respectively. The optical disk 226 can be a CD or a DVD, while the magnetic disk 228 can be a magnetic floppy disk or diskette. The hard disk drive 218, optical disk drive 222 and magnetic disk drive 224 communicate with the processing unit 206 via the system bus 210. The hard disk drive 218, optical disk drive 222 and magnetic disk drive 224 may include interfaces or controllers (not shown) coupled between such drives and the system bus 210, as is known by those skilled in the relevant art. The drives 218, 222, 224, and their associated computer-readable media 220, 226, 228, provide nonvolatile storage of computer-readable instructions, data structures, program modules and other data for the ordering system 106. Those skilled in the relevant art will appreciate that other types of computer-readable media may be employed to store data accessible by a computer, such as magnetic cassettes, flash memory cards, Bernoulli cartridges, RAMs, ROMs, smart cards, etc.

Program modules can be stored in the system memory 208, such as an operating system 230, one or more application programs 232, other programs or modules 234, drivers 236 and program data 238.

The application program(s) 232 may include logic capable of accepting orders for framed prints, and optionally fulfilling those orders. For example, where the user or customer selects an image and specifies framing information via a mobile device, the ordering system 106 may log the order, and optionally ensure that the custom framed print is assembled and shipped. The application program(s) 232 may, for example, be stored within the system memory 208 as one or more sets of logic or one or more sets of machine-executable instructions. The application program(s) 232 may, for example, ensure that confirmation is sent to the mobile device, as well as sending tracking updates. The application program(s) 232 may, for example, perform debiting or other financial transactions associated with the orders.

The system memory 208 may include communications programs 240 that permit the ordering system 106 to access and exchange data with other networked systems or components, such as other mobile devices 102, an external computer system, or the like.

While shown in FIG. 2 as being stored in the system memory 208, the operating system 230, application programs 232, other programs/modules 234, drivers 236, program data 238 and communications 240 can be stored on the hard disk 220 of the hard disk drive 218, the optical disk 226 of the optical disk drive 222 and/or the magnetic disk 228 of the magnetic disk drive 224.

Authorized personnel can enter commands (i.e., system maintenance, upgrades, etc.) and information (i.e., product information, pricing, sales, etc.) into the ordering system 106 using one or more communicably coupled input devices such as a touch screen or keyboard 242, a pointing device such as a mouse 244, and/or a push button (not shown). Other input devices can include a microphone, joystick, game pad, tablet, scanner, biometric scanning device, etc. These and other input devices are connected to the processing unit 206 through an interface 246 such as a universal serial bus (“USB”) interface that couples to the system bus 210, although other interfaces such as a parallel port, a game port or a wireless interface or a serial port may be used. A monitor 248 or other display device is coupled to the system bus 210 via a video interface 250, such as a video adapter. In at least some instances, the input devices may be located proximate the ordering system 106, for example when the system is installed on the system user's premises. In other instances, the input devices may be located remote from the ordering system 106, for example when the system is installed on the premises of a service provider.

In some embodiments, the ordering system 106 operates in an environment 100 (FIG. 1) using one or more of the logical connections to optionally communicate with one or more remote computers, servers and/or other devices via one or more communications channels 214—for example, one or more networks. These logical connections may facilitate any known method of permitting computers to communicate, such as through one or more LANs and/or WANs. Such networking environments are well known in wired and wireless enterprise-wide computer networks, intranets, extranets, and the Internet.

In some embodiments, a network interface 256, communicatively linked to the system bus 210, may be used for establishing and maintaining communications over the communications channels 214. Further, the data store interface 252, which is communicatively linked to the system bus 210, may be used for establishing communications with a data store 260 located on one or more computer-readable media 260. For example, such a data store 260 may include a repository for storing information regarding orders, end user account information, end user mobile device information, system user specific information relevant to providing one or more products or services (e.g., framed prints) to the end user, or combinations thereof. In some embodiments, the database interface 252 may communicate with a remote data store via the communications channels 214.

In an environment 100 (FIG. 1), program modules, application programs, or data, or portions thereof, can be stored in another server computing system (not shown). Those skilled in the relevant art will recognize that the network connections shown in FIG. 2 are only some examples of ways of establishing communications between computers, and other connections may be used, including wirelessly. In some embodiments, program modules, application programs, or data, or portions thereof, can even be stored in other computer systems or other devices (not shown).

For convenience, the processor 206, system memory 208, network port 256 and interfaces 246, 252 are illustrated as communicatively coupled to each other via the system bus 210, thereby providing connectivity between the above-described components. In alternative embodiments, the above-described components may be communicatively coupled in a different manner than illustrated in FIG. 2. For example, one or more of the above-described components may be directly coupled to other components, or may be coupled to each other, via intermediary components (not shown). In some embodiments, system bus 210 is omitted and the components are coupled directly to each other using suitable connections.

The mobile device 104 can include any device, system or combination of systems and devices having at least wireless communications capabilities. In most instances, the mobile device 104 includes additional devices, systems, or combinations of systems and devices capable of providing graphical data display capabilities. Examples of such mobile devices 104 can include without limitation, cellular telephones, smartphones, tablet computers, laptop computers, ultraportable or netbook computers, personal digital assistants, handheld devices, and the like.

The mobile device 104 includes one or more processors 282 and nontransitory computer- or processor-readable media, for instance one or more nonvolatile memories such as read-only memory (ROM) or flash memory 284 and/or one or more volatile memories such as random access memory (RAM) 286.

The mobile device 104 includes one or more radios 288a-288c (three shown, collectively 288) and associated antennas 290a-290c (three shown, collectively 290). For example, the mobile device 104 may include one or more cellular transceivers or radios 288a, one or more Wi-Fi® transceivers or radios 288b and one or more Bluetooth® transceivers or radios 288, along with associated antennas 290a-290c, respectively 284.

The mobile device 104 includes a user input/output subsystem, for example including a touchscreen or touch sensitive display device 292a, one or more speakers 292b, and one or more microphones 292c. The touchscreen or touch sensitive display device 292a can include any type of touchscreen including, but not limited to, a resistive touchscreen or a capacitive touchscreen. The touchscreen or touch sensitive display device 292a may present a graphical user interface, for example in the form of a number of distinct screens or windows, which include prompts and/or fields to select images, present framing options and to specify framing options for an order. The touchscreen or touch sensitive display device 292a may present or display individual icons and controls, for example virtual buttons or slider controls and virtual keyboards or key pads which are used to communicate instructions, commands, and/or data. While not illustrated, the user interface may additionally or alternatively include one or more additional input or output devices, for example an alphanumeric keypad, a QWERTY keyboard, a joystick, scroll wheel, touchpad or similar physical or virtual input device.

The mobile device 104 preferably includes one or more image capture devices, for example cameras with suitable lenses, and optionally one or more flashes or lights for illuminating a field of view to capture images. The camera(s) may capture still digital images or moving or video digital images. Image information may be stored as files via the flash memory 284, forming a library of images from which a user or consumer may choose to have printed and framed.

Some or all of the components within the mobile device 104 may be communicably coupled using at least one bus 296 or similar structure adapted to transferring, transporting, or conveying data between the devices, systems, or components used within the mobile device 104. The bus 296 can include one or more serial communications links or a parallel communications link such as an 8-bit, 16-bit, 32-bit, or 64-bit data bus. In some embodiments, a redundant bus (not shown) may be present to provide failover capability in the event of a failure or disruption of the primary bus 296.

The processor(s) 282 may include any type of processor (e.g., ARM Cortext-A8, ARM Cortext-A9, Snapdragon 600, Snapdragon 800, NVidia Tegra 4, NVidia Tegra 4i, Intel Atom Z2580, Samsung Exynos 5 Octa, Apple A7, Motorola X8) adapted to execute one or more machine-executable instruction sets, for example a conventional microprocessor, a reduced instruction set computer (RISC) based processor, an application specific integrated circuit (ASIC), digital signal processor (DSP), or similar logic processing unit. Within the processor(s) 282, a non-volatile memory may store all or a portion of a basic input/output system (BIOS), boot sequence, firmware, startup routine, and communications device operating system (e.g., iOS®, Android®, Windows® Phone, Windows® 8, and similar) executed by the processor 282 upon initial application of power. The processor(s) 282 may also execute one or more sets of logic or one or more machine-executable instruction sets loaded from the memory 286 subsequent to the initial application of power to the processor 282. The processor 282 may also include a system clock, a calendar, or similar time measurement devices. One or more geolocation devices, for example a Global Positioning System (GPS) receiver and one or more position sensing devices (e.g., one or more microelectromechanical systems or “MEMS” accelerometers, gyroscopes, etc.) that are not shown in FIG. 2 may be communicably coupled to the processor 282 to provide additional functionality such as geolocation data and three-dimensional position data to the processor 282.

The transceivers or radios 288 can include any device capable of transmitting and receiving communications via electromagnetic energy.

Non-limiting examples of cellular communications transceivers or radios 288a include a CDMA transceiver, a GSM transceiver, a 3G transceiver, a 4G transceiver, an LTE transceiver, and any similar current or future developed mobile device transceiver having at least one of a voice telephony capability or a graphical data exchange capability. In at least some instances, the cellular transceivers or radios 288a can include more than one interface. For example, in some instances, the cellular transceivers or radios 288a can include at least one dedicated, full- or half-duplex, voice call interface and at least one dedicated data interface. In other instances, the cellular transceivers or radios 288a can include at least one integrated interface capable of contemporaneously accommodating both full- or half-duplex voice calls and data transfer.

Non-limiting examples of Wi-Fi transceivers or radios 288b include various chipsets available from Broadcom, including BCM43142, BCM4313, BCM94312MC, BCM4312, and Wi-Fi chipsets available from Atmel, Marvell, or Redpine. Non-limiting examples of Wi-Fi transceivers or radios 288b include various chipsets available from Broadcom, Texas Instruments and Redpine.

As noted, nontransitory computer- or processor-readable media can include non-volatile storage memory, and in some embodiments may also include a volatile memory as well. At least a portion of the memory is used to store one or more machine-executable instruction sets for execution by the processor 282. In some embodiments, all or a portion of the memory may be disposed within the processor 282, for example in the form of a cache. In some embodiments, the memory may be supplemented with one or more slots configured to accept the insertion of one or more removable memory devices such as a secure digital (SD) card, a compact flash (CF) card, a universal serial bus (USB) memory “stick”, or the like.

In at least some implementations, one or more sets of logic or machine-executable instructions providing applications or “apps” executable by the processor 282 may be stored in whole or in part in at least a portion of the memory 284, 286. In at least some instances, the applications may be downloaded or otherwise acquired by the end user, for example using an online marketplace such as the Apple App Store, Amazon Marketplace, or Google Play marketplaces. In some implementations, such applications may start up in response to selection of a corresponding user selectable icon by the user or consumer. The application can facilitate establishing a data link between the mobile device 104 and the ordering system 106 via the transceivers or radios 288 and communications channels 214.

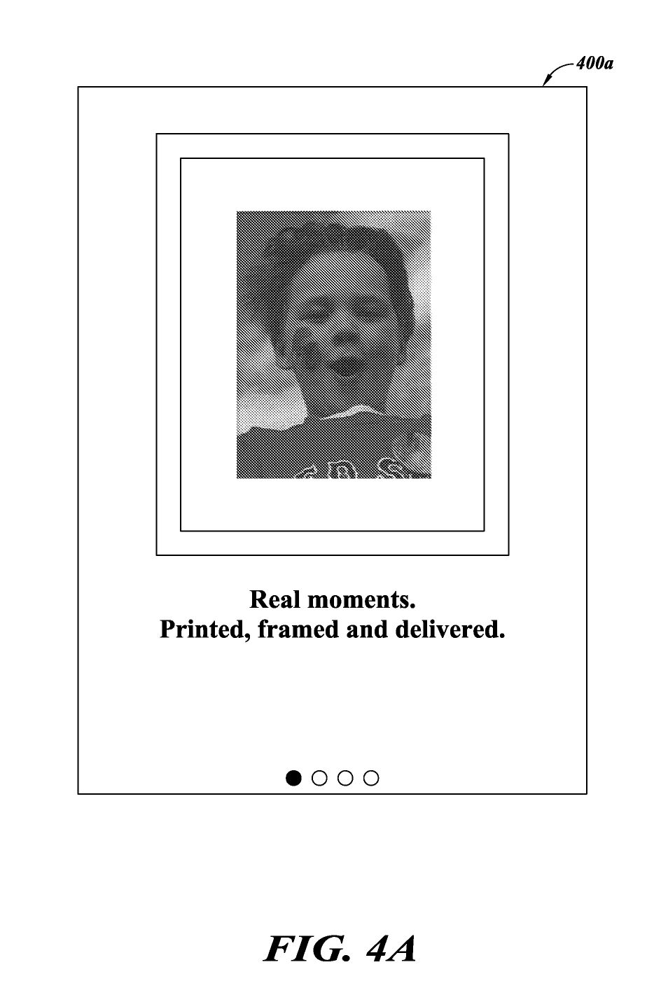

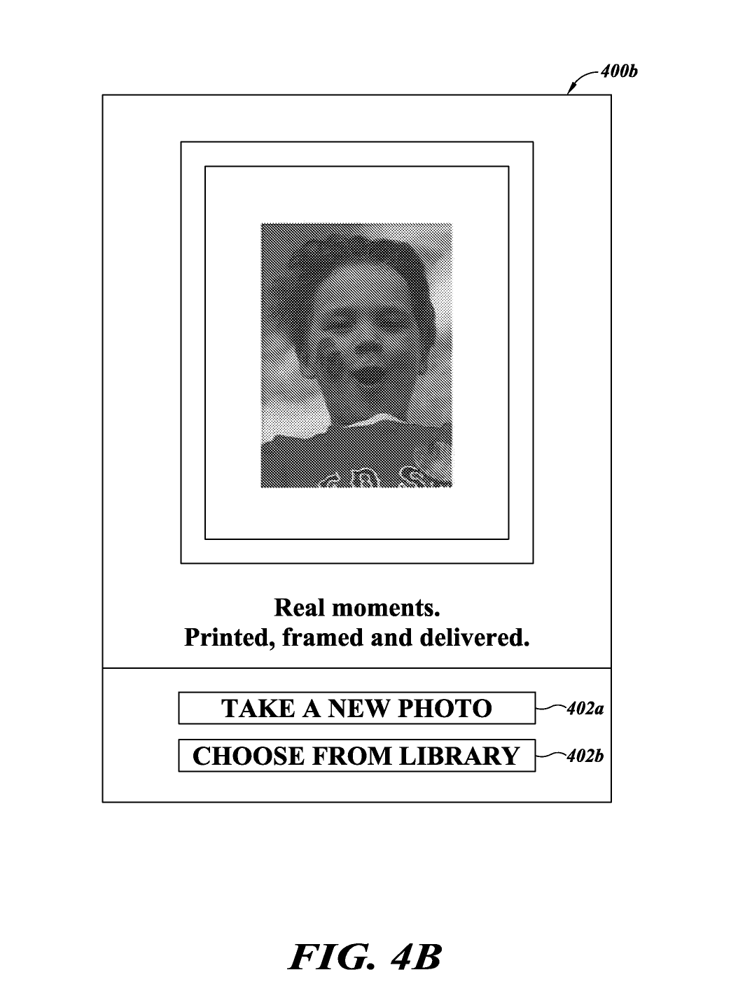

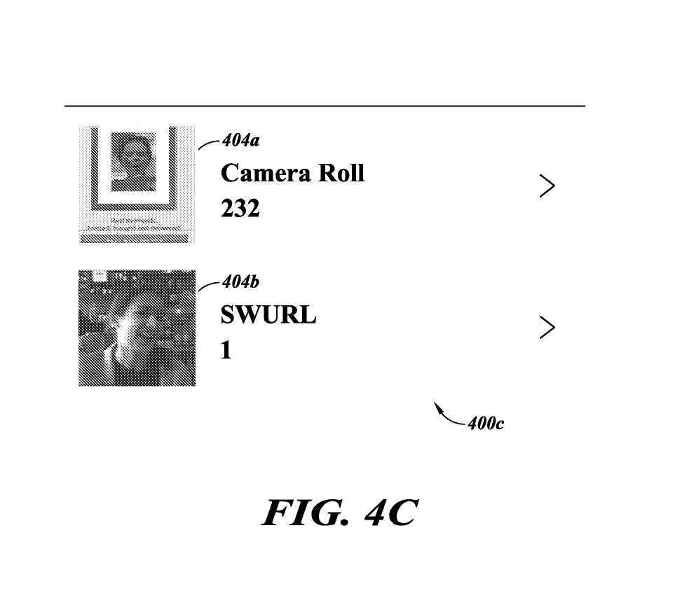

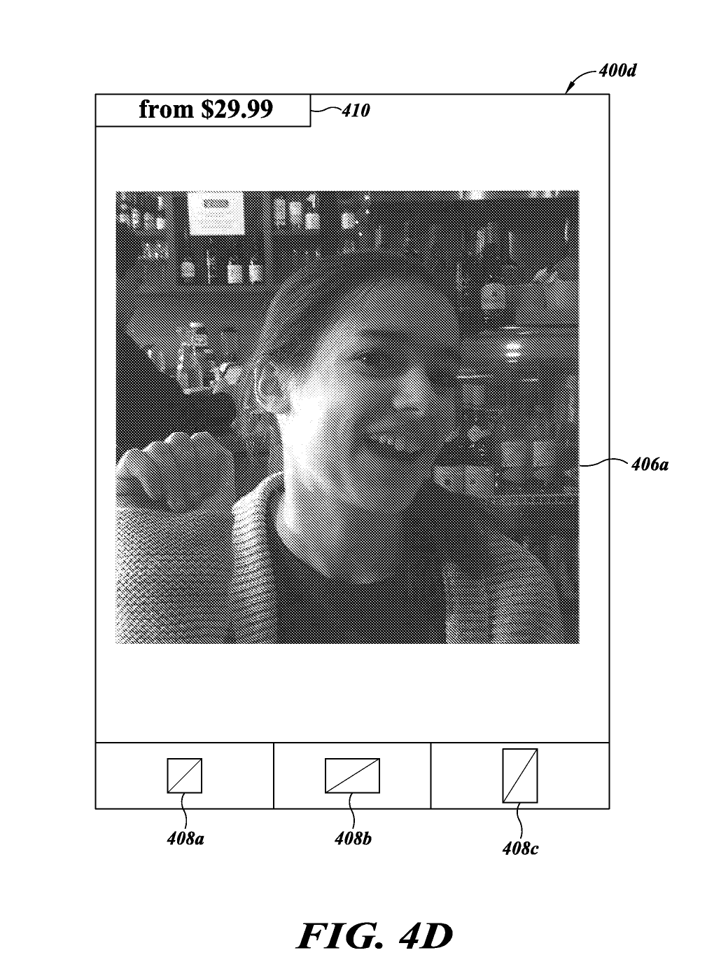

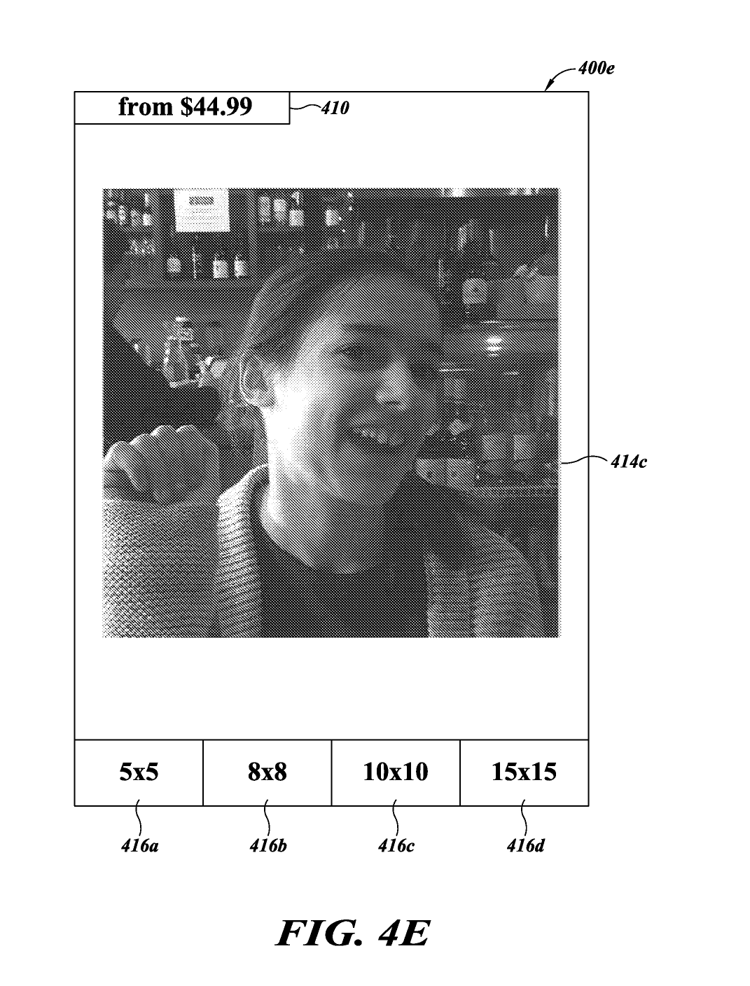

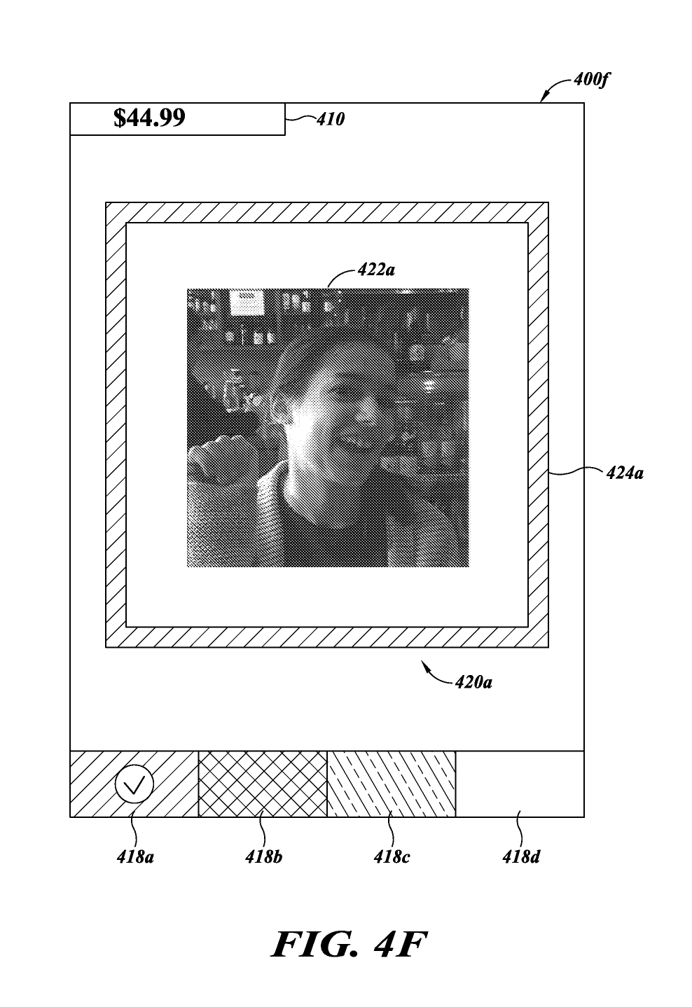

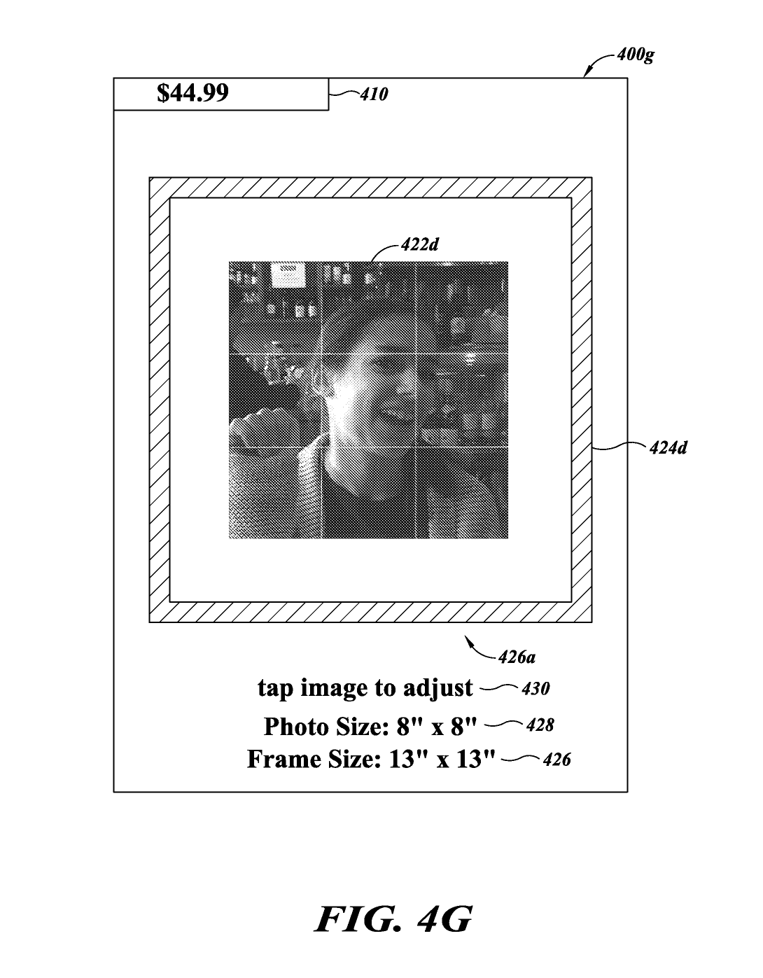

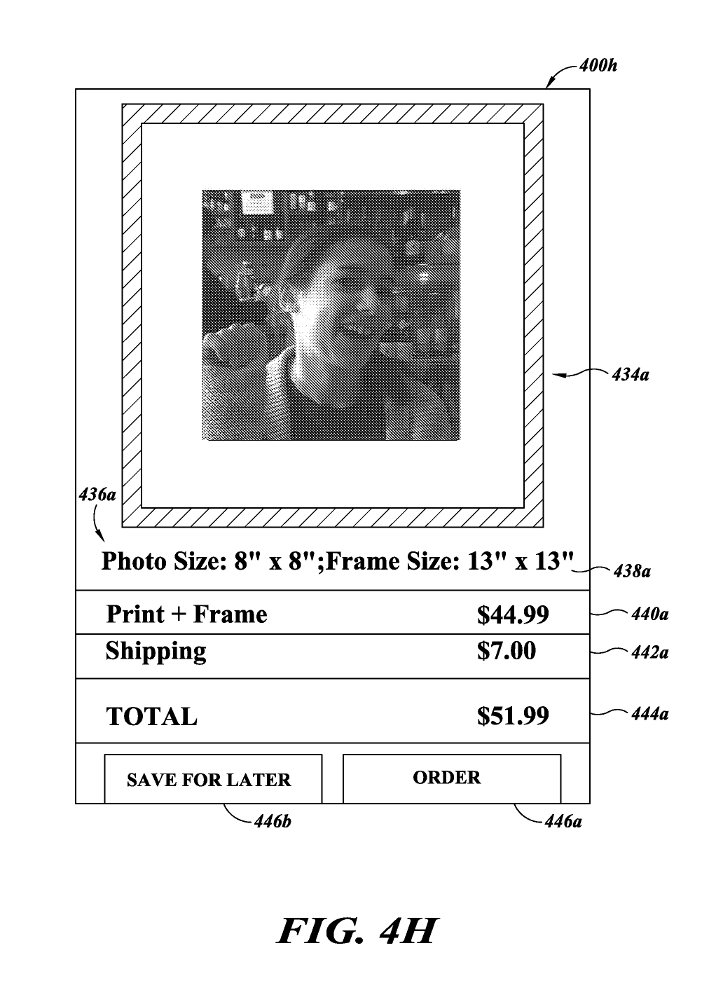

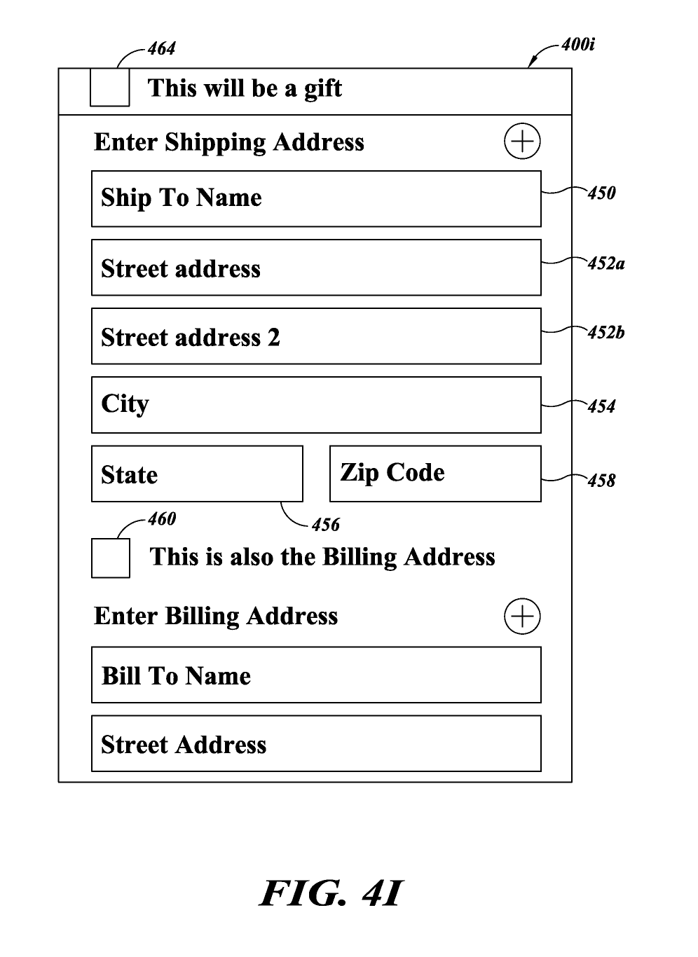

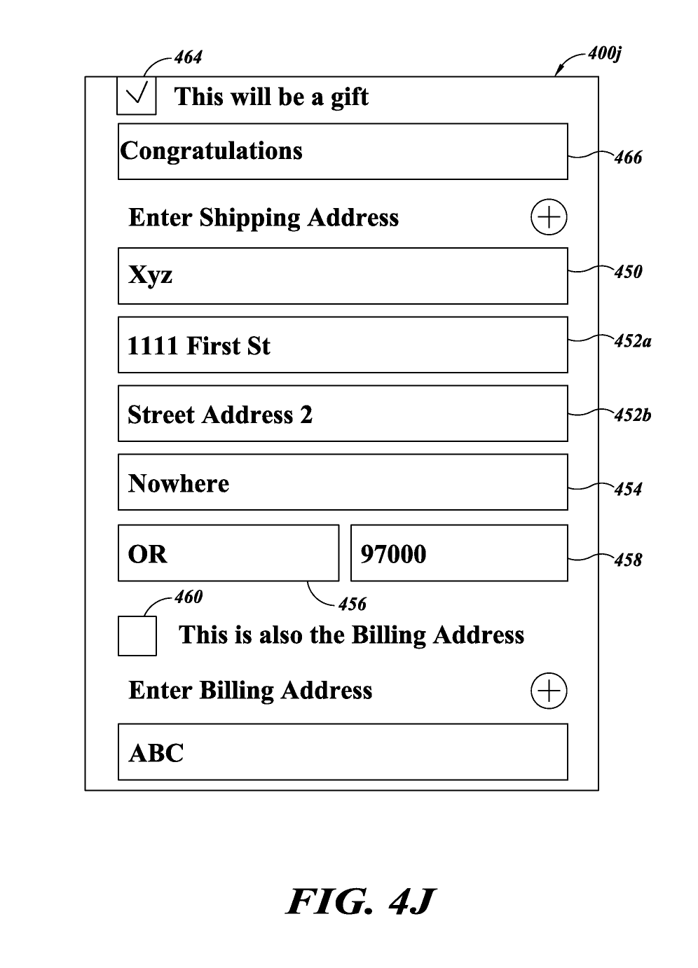

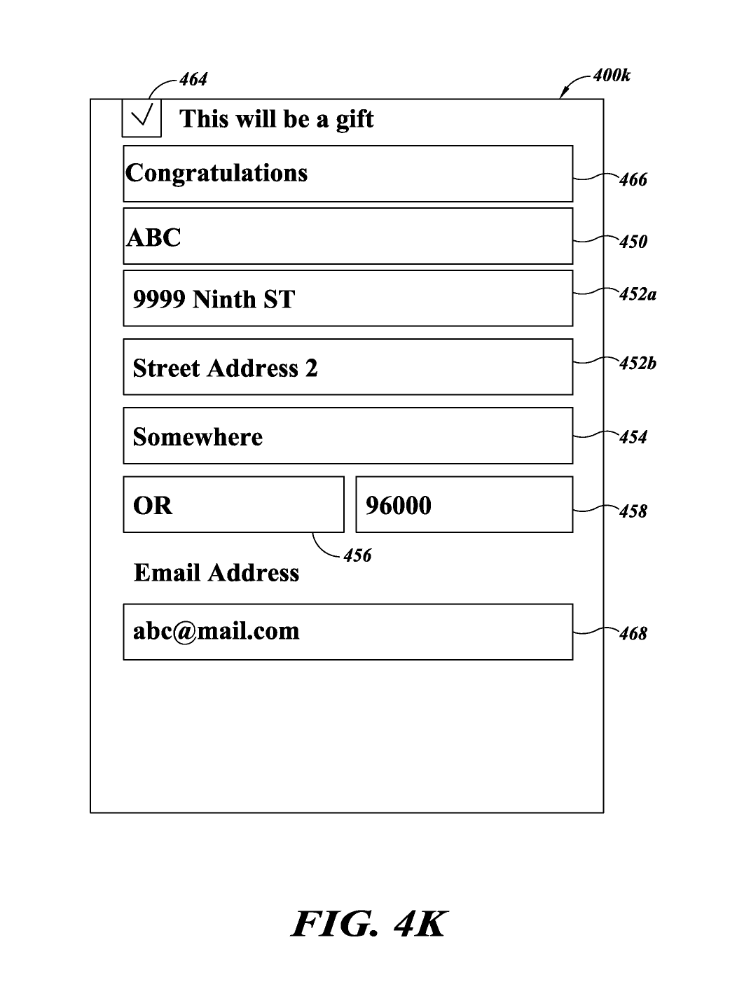

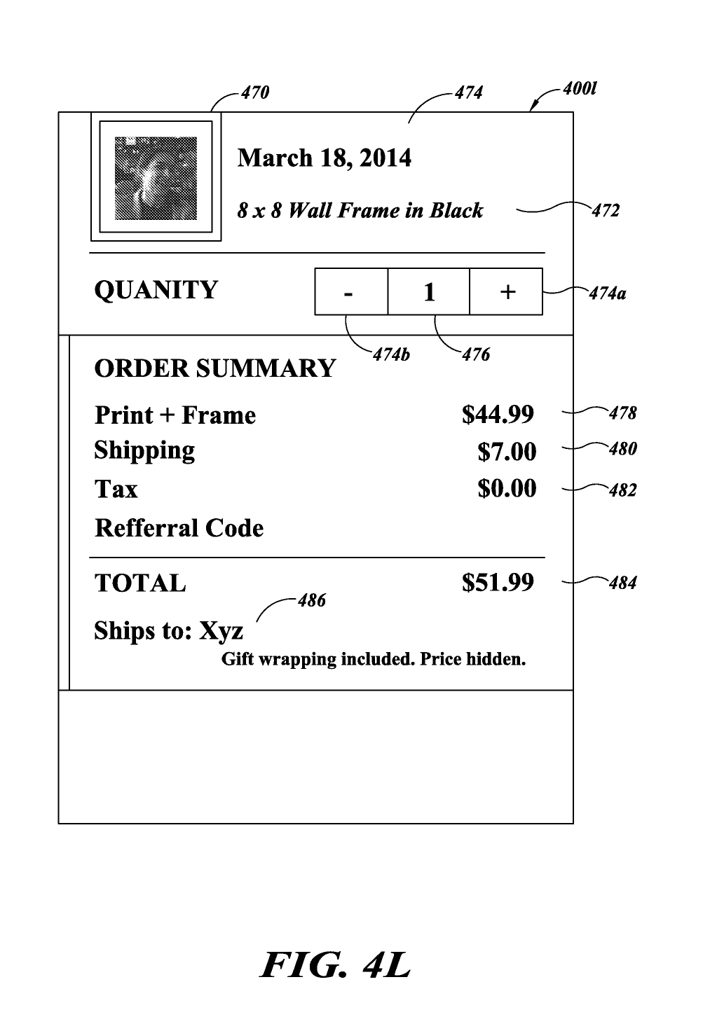

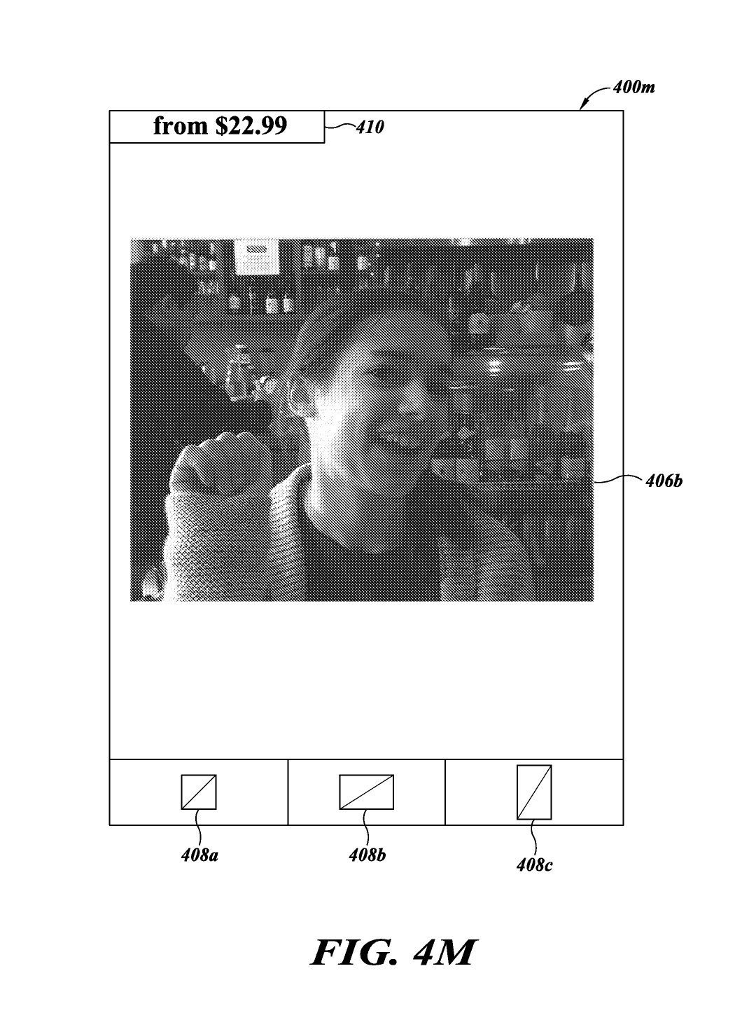

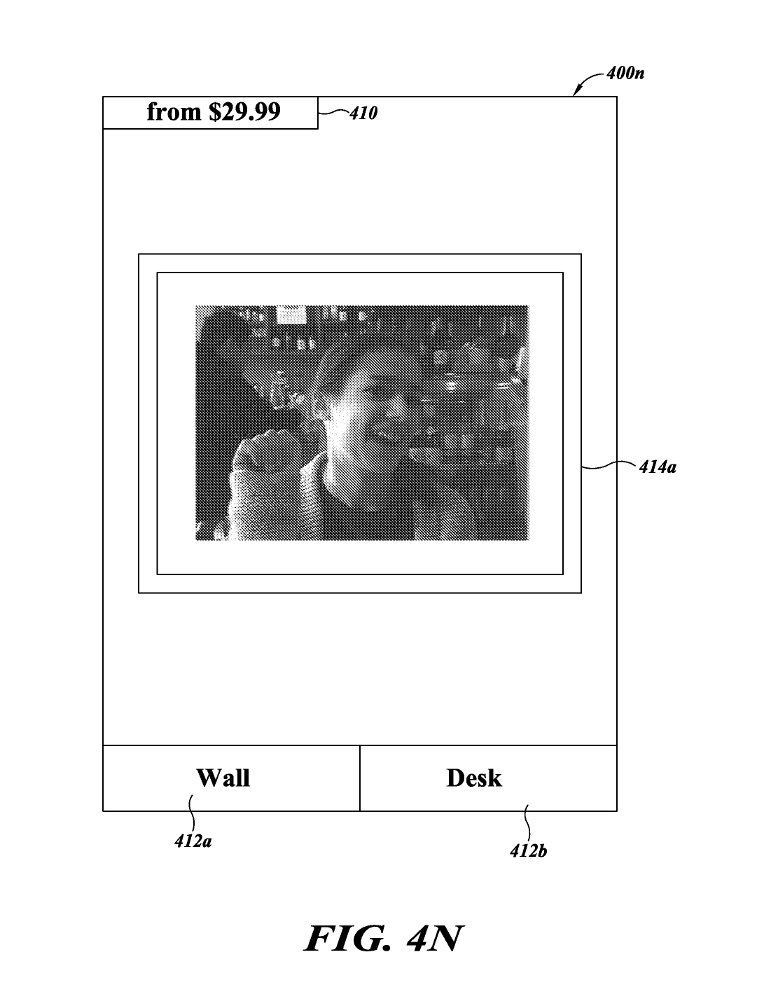

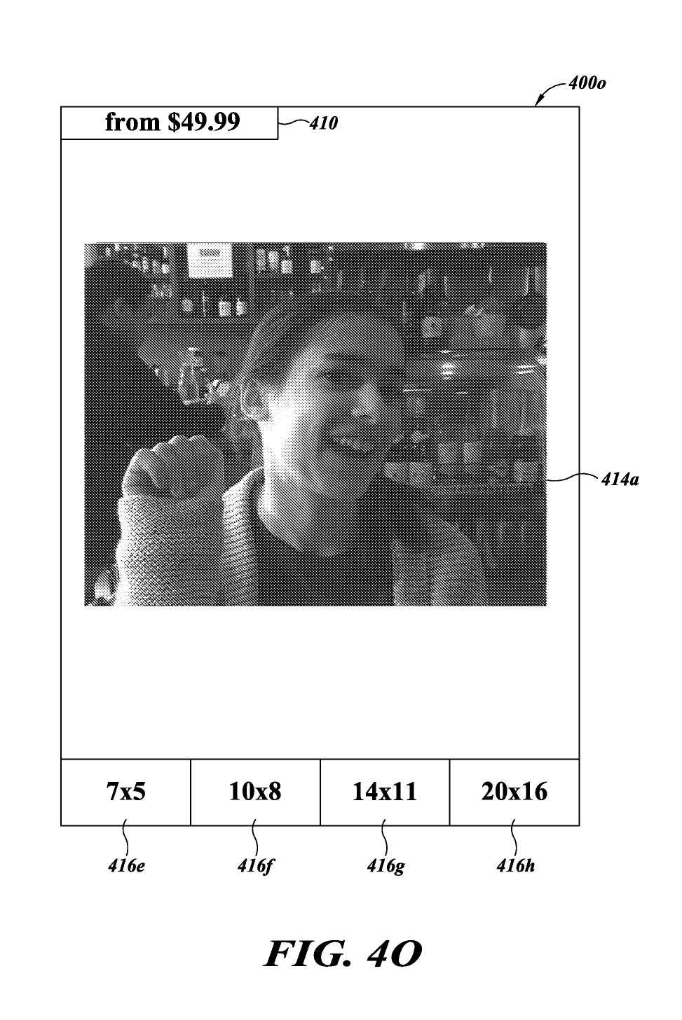

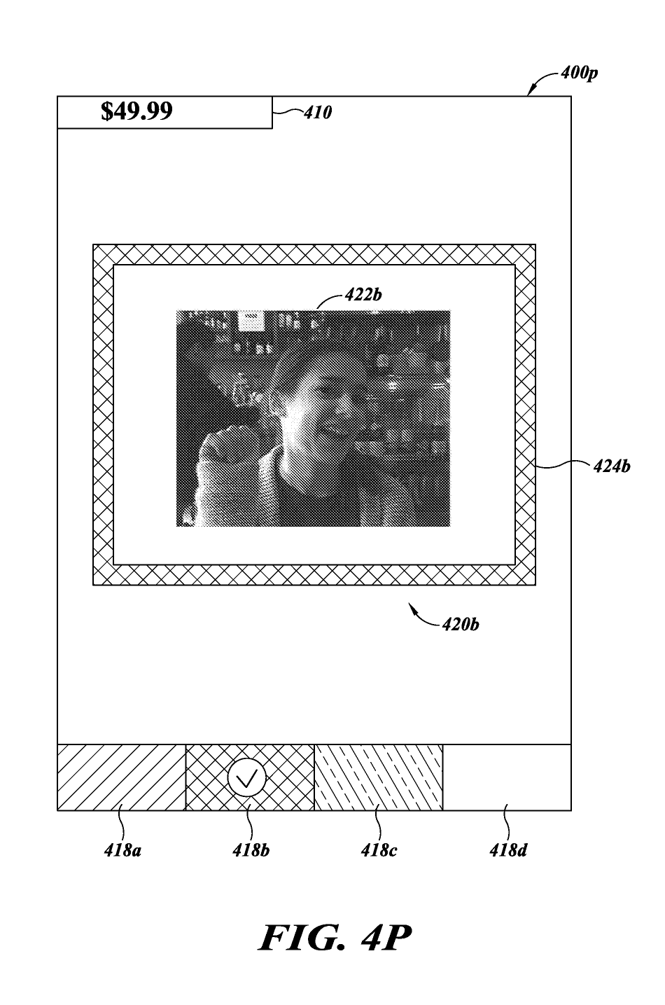

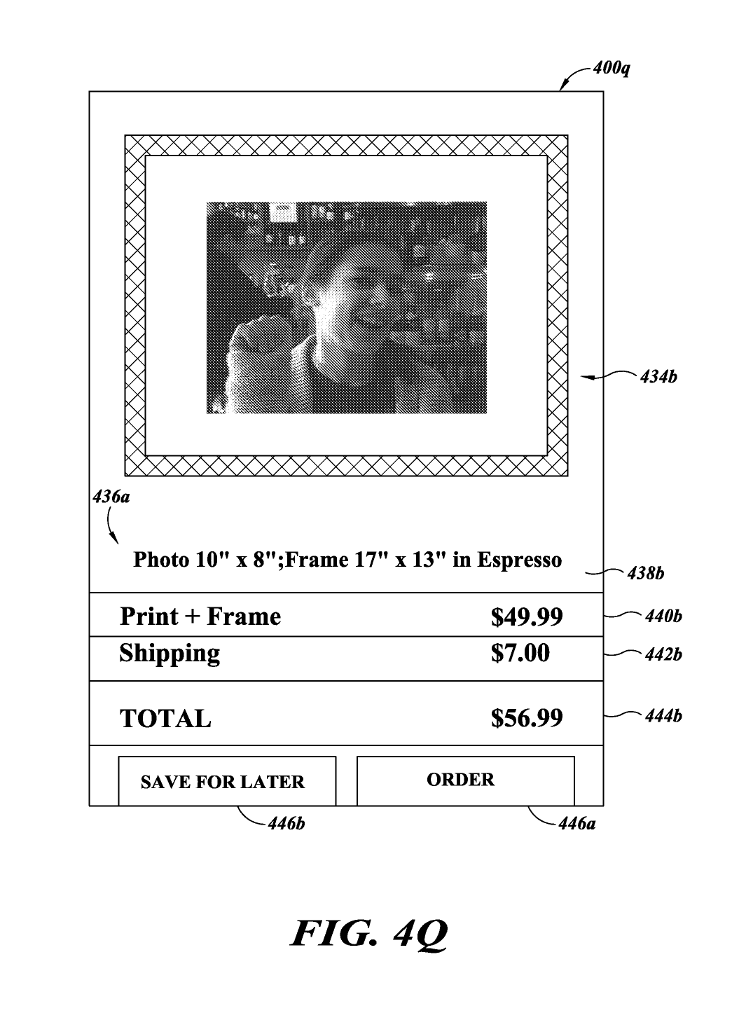

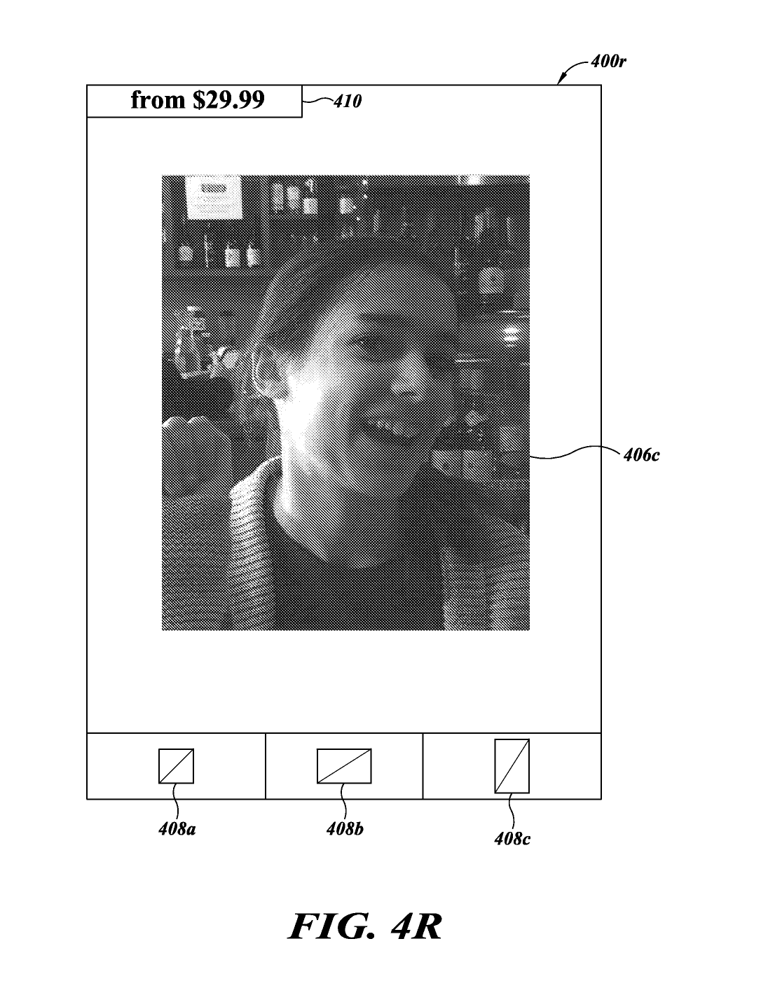

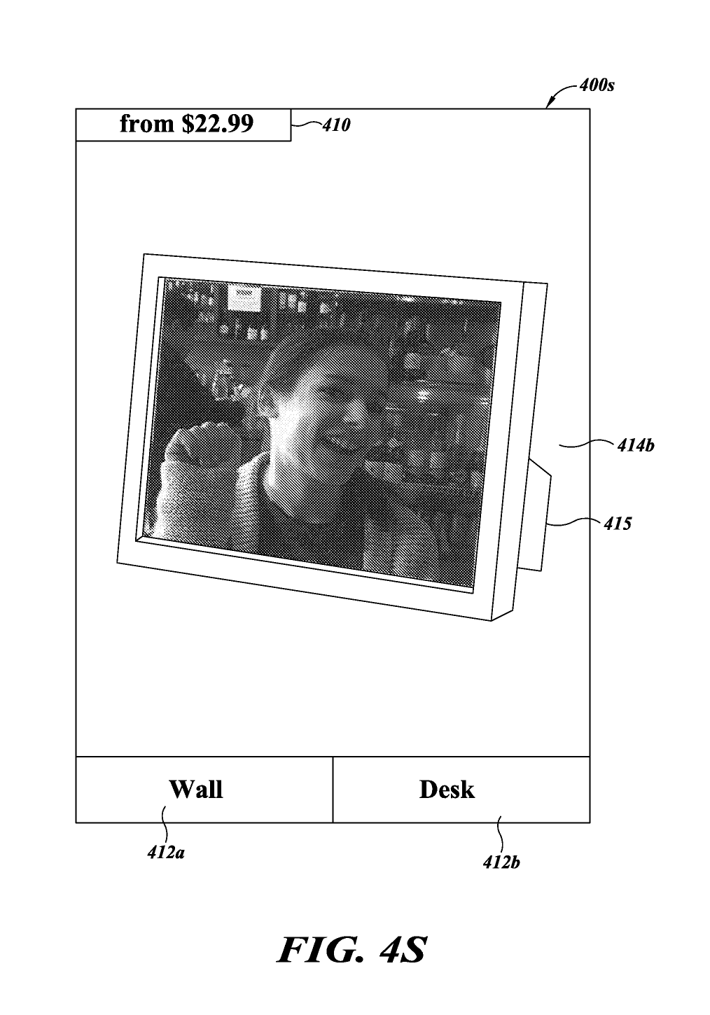

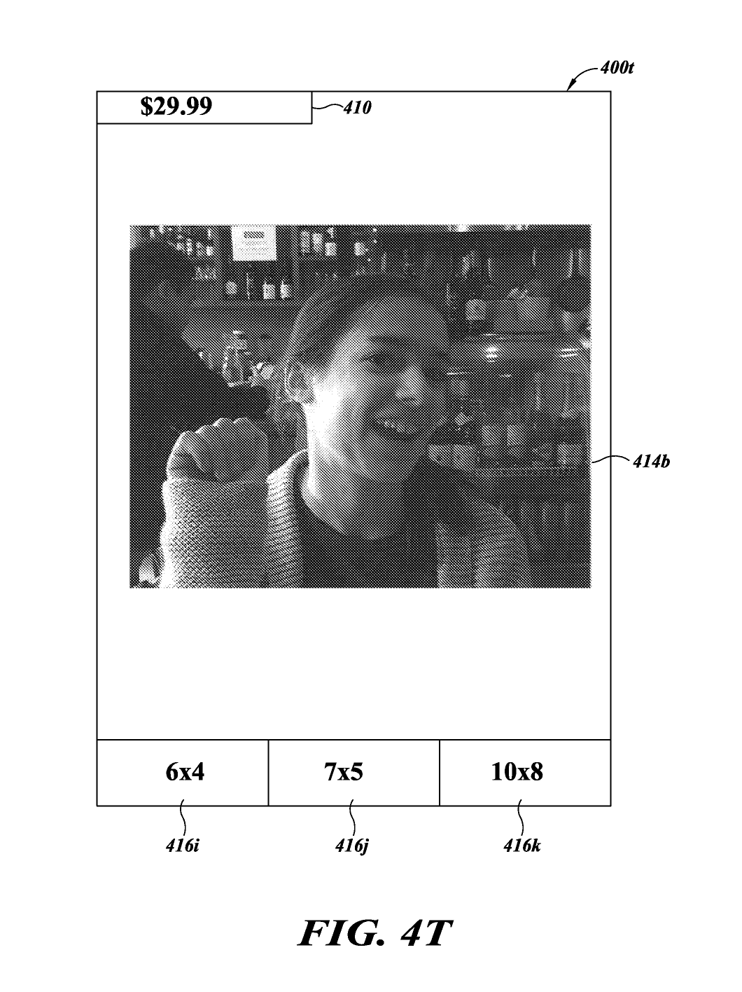

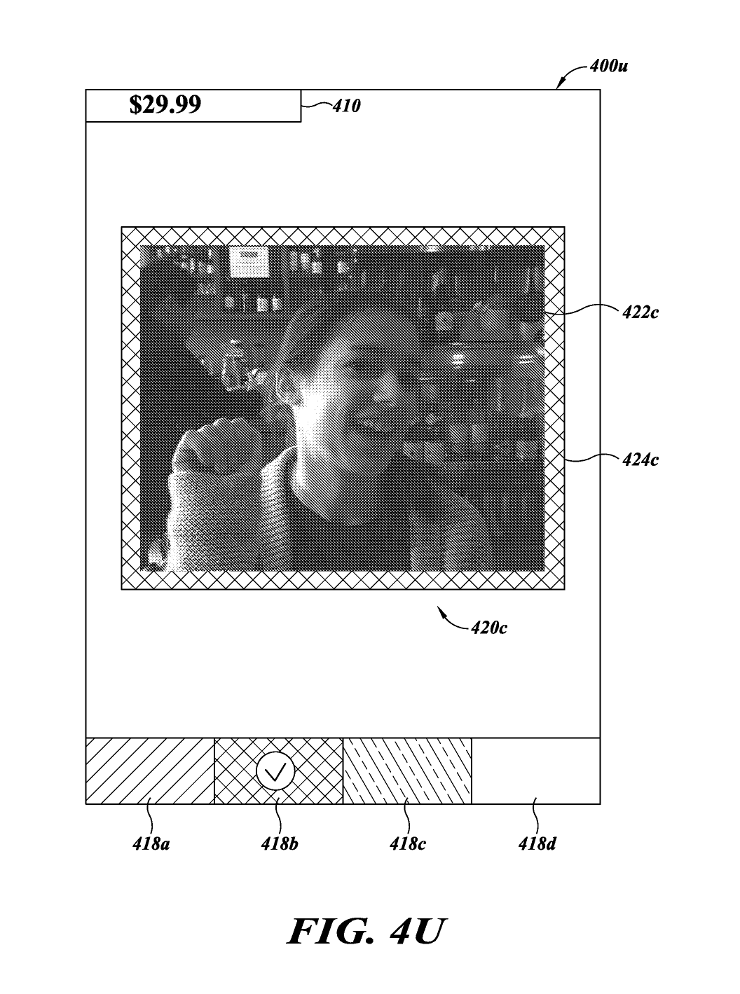

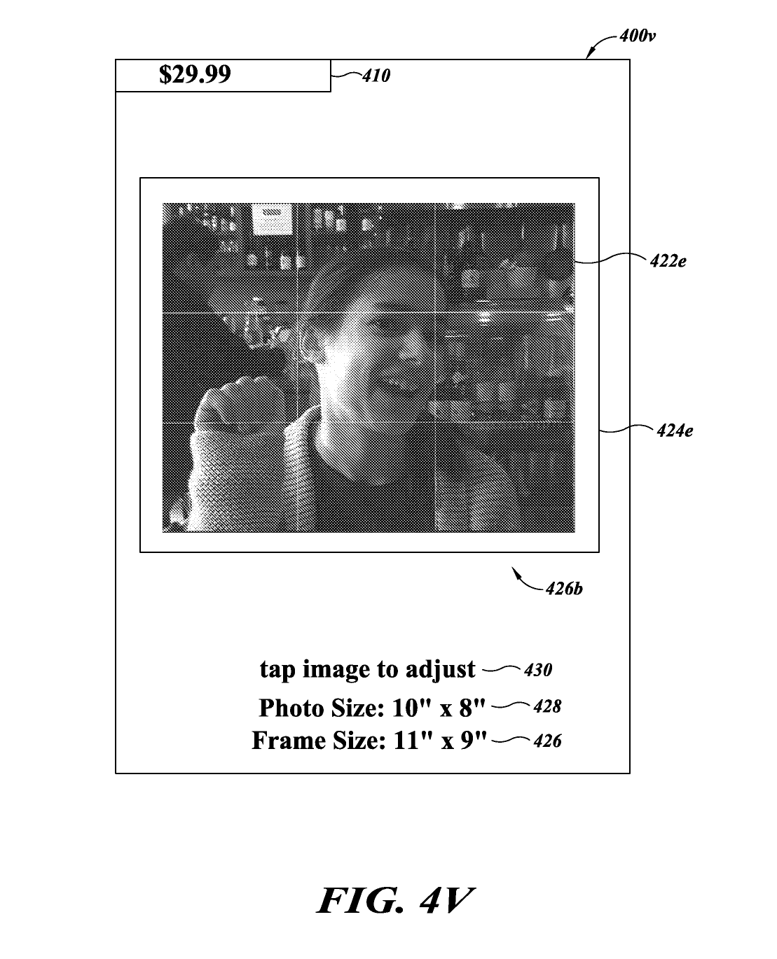

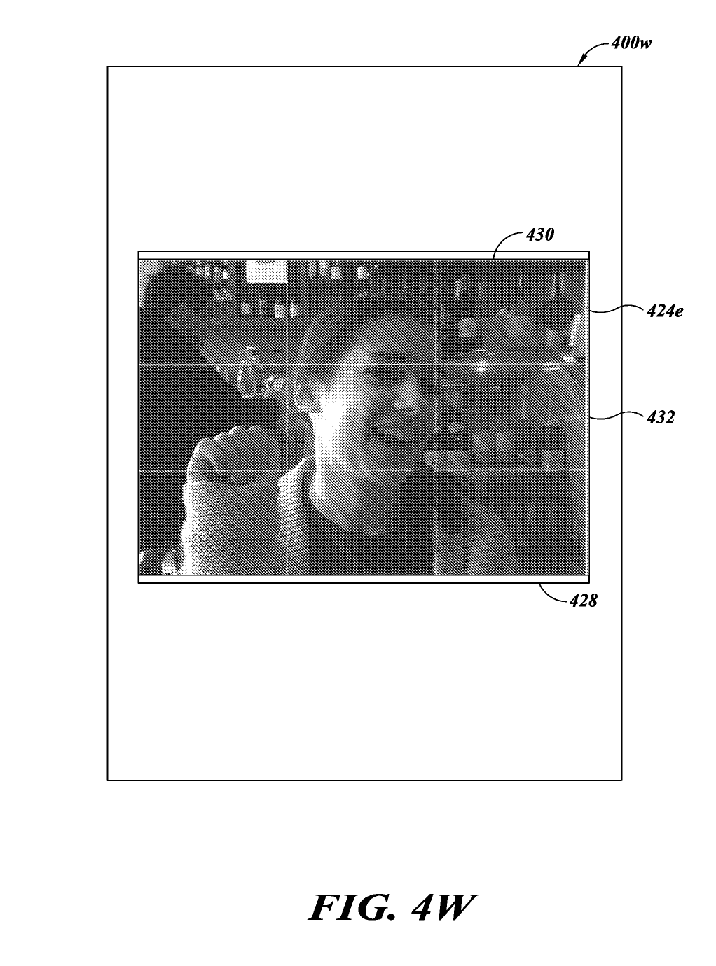

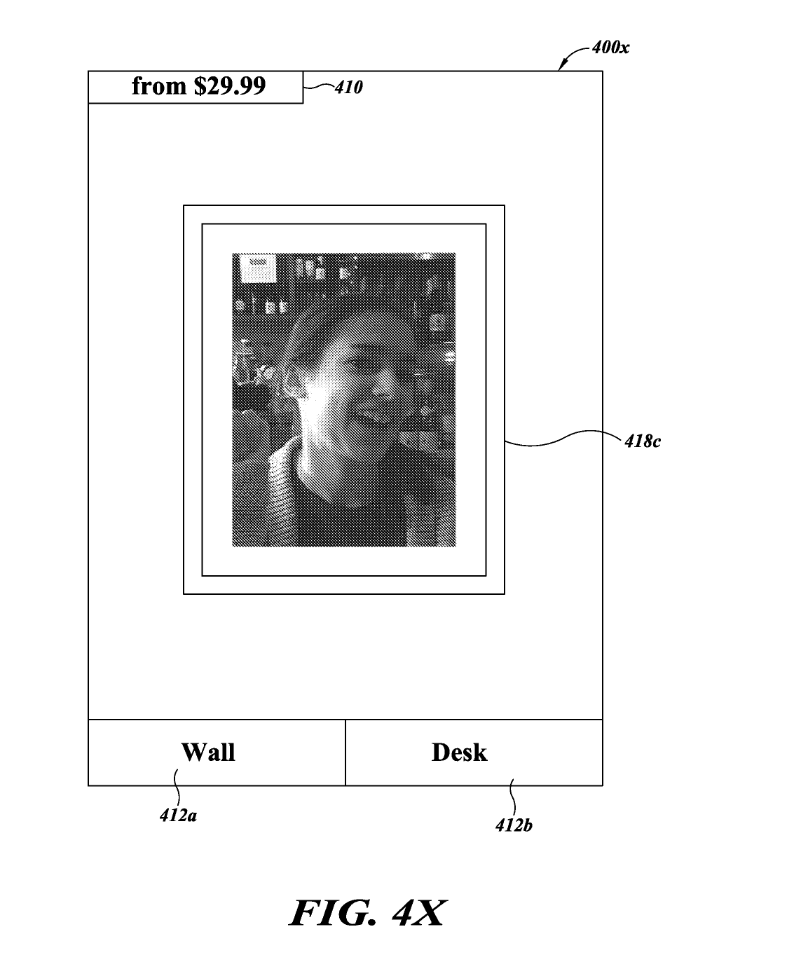

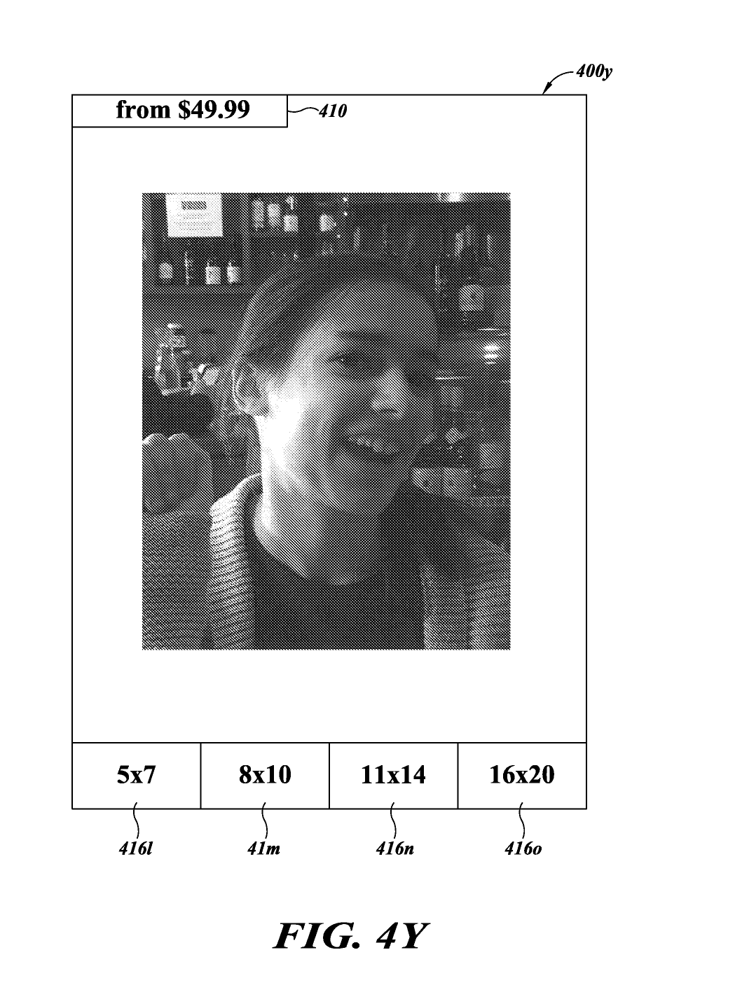

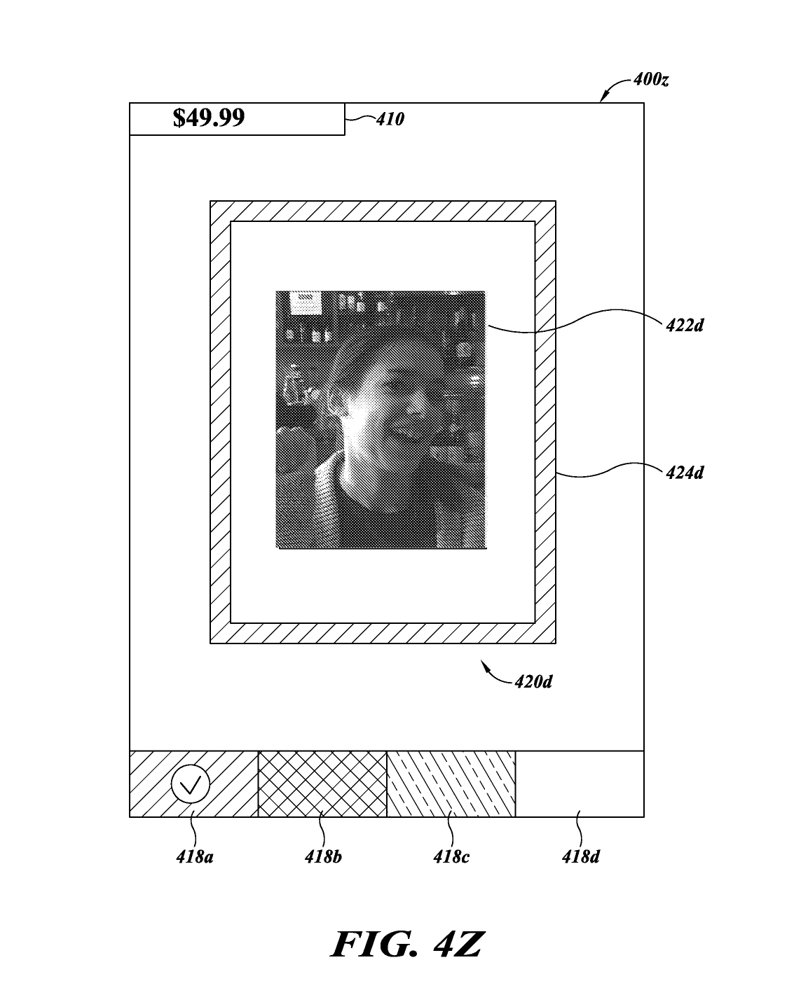

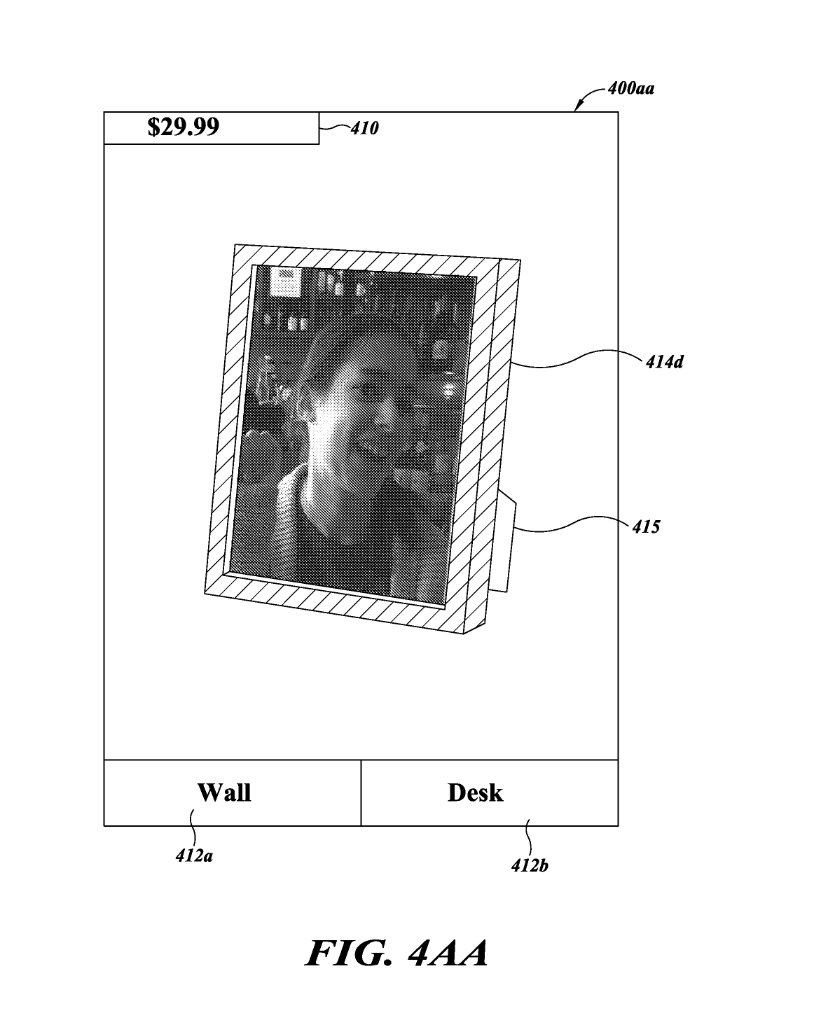

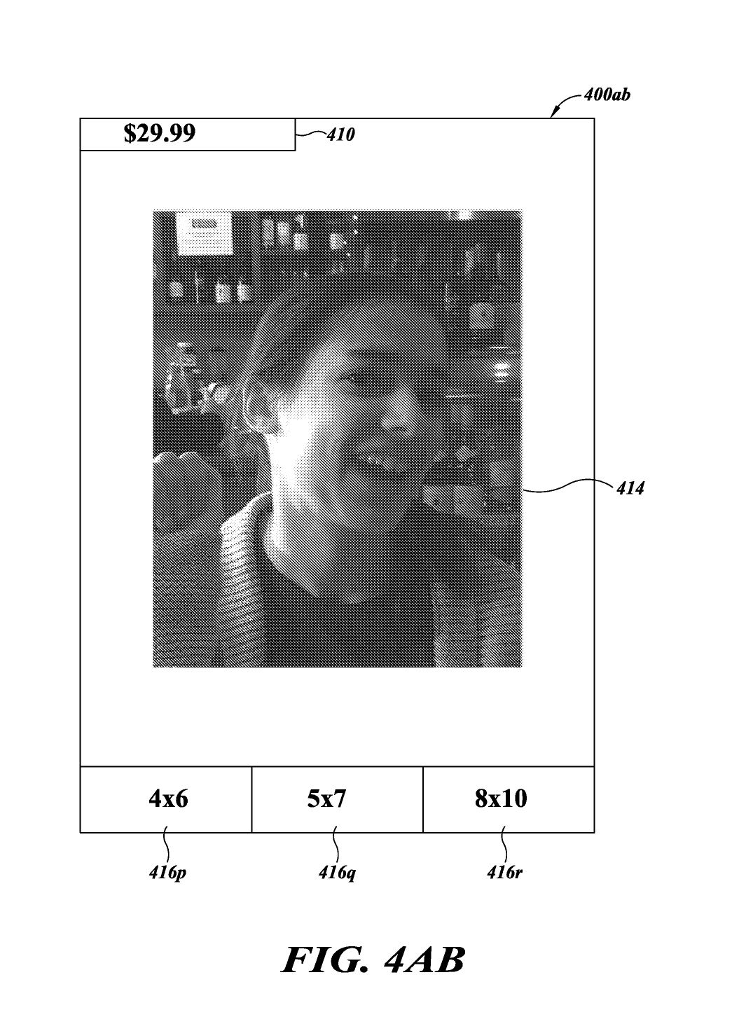

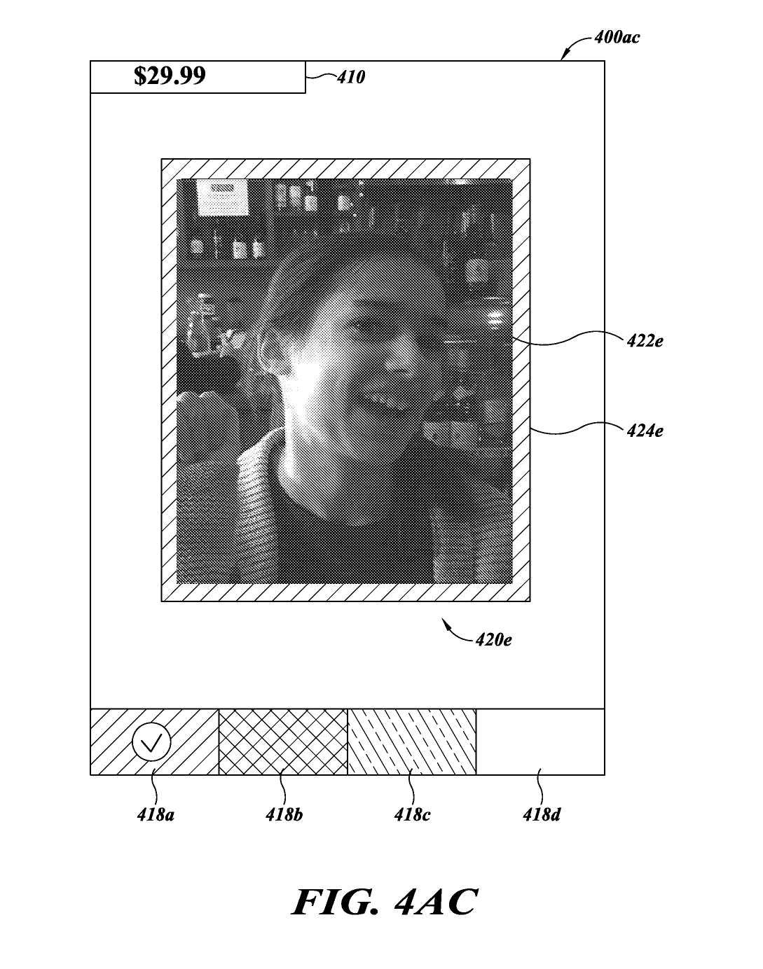

As discussed in more detail below, the application(s) may include logic or instructions to provide the end user with access to a number of graphical screens or windows with prompts, fields, and other user interface structures that allow the user or consumer to select an image, select framing specifications including framing options and frame characteristics, and place an order for a framed print via the ordering system 106. Such may include, for example, logic or machine-executable instructions for various screens or windows, examples of which are generally illustrated in FIGS. 4A-4Z, 4AA, AB, 4AC, and discussed below.

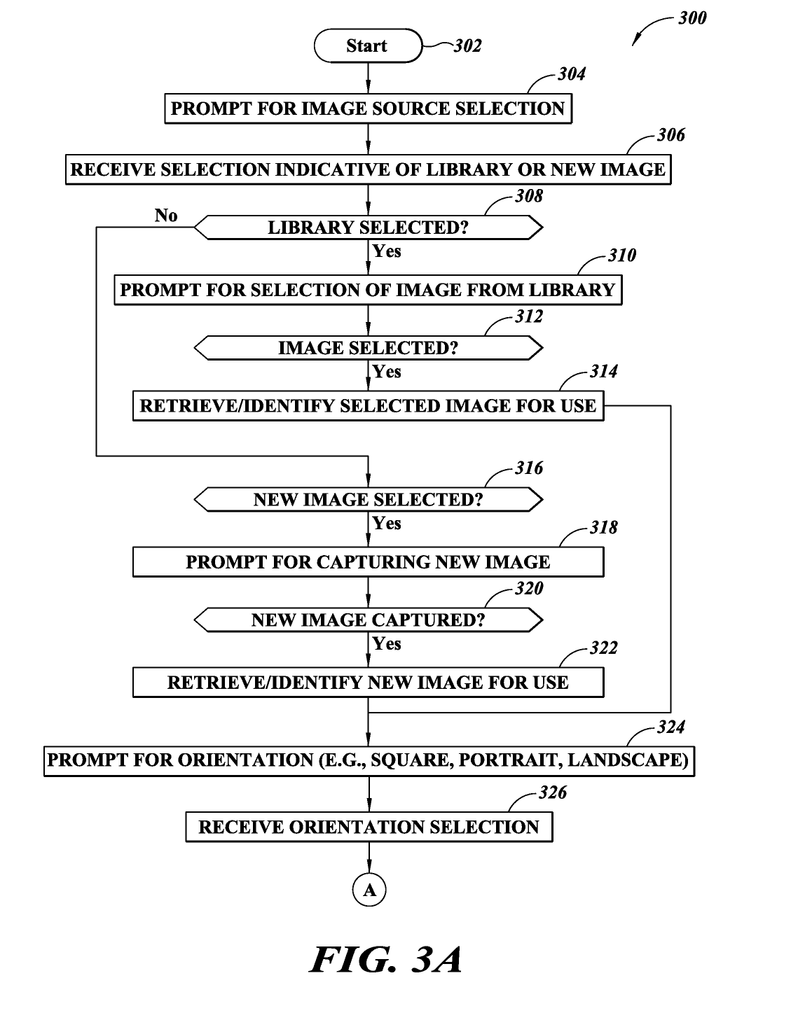

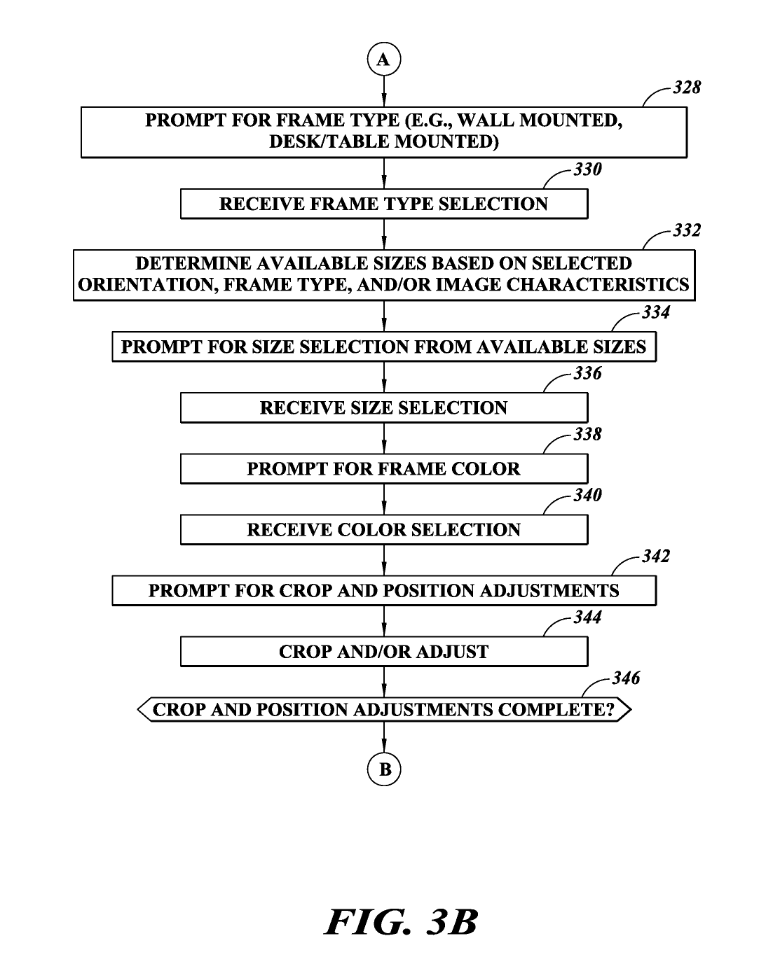

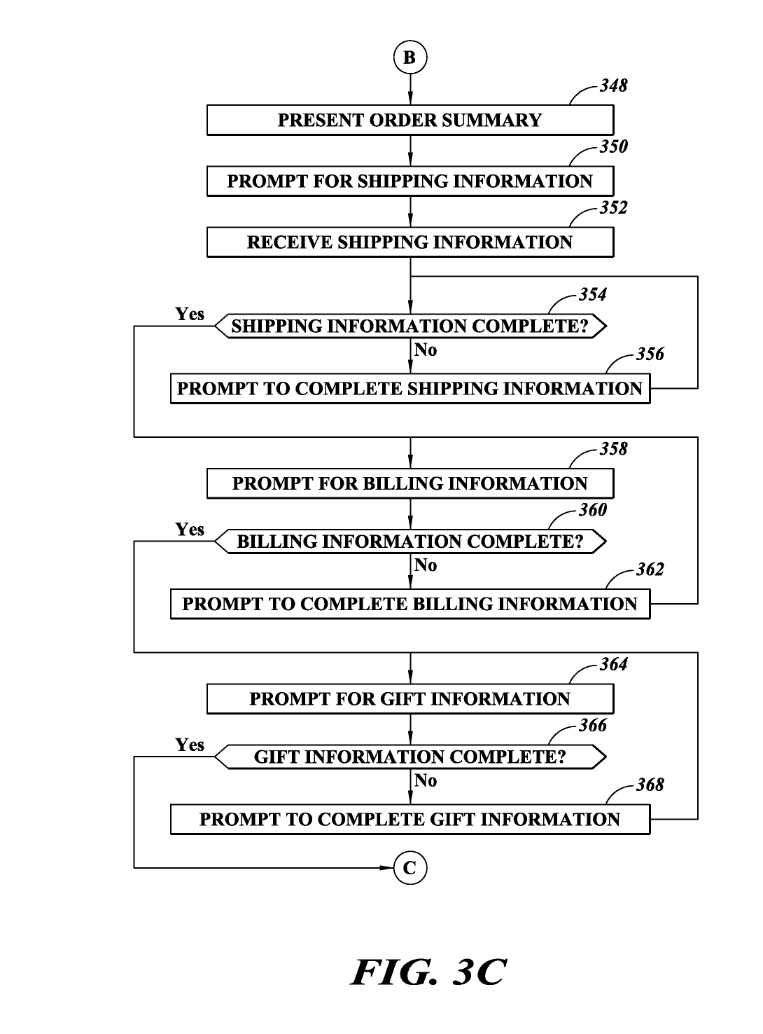

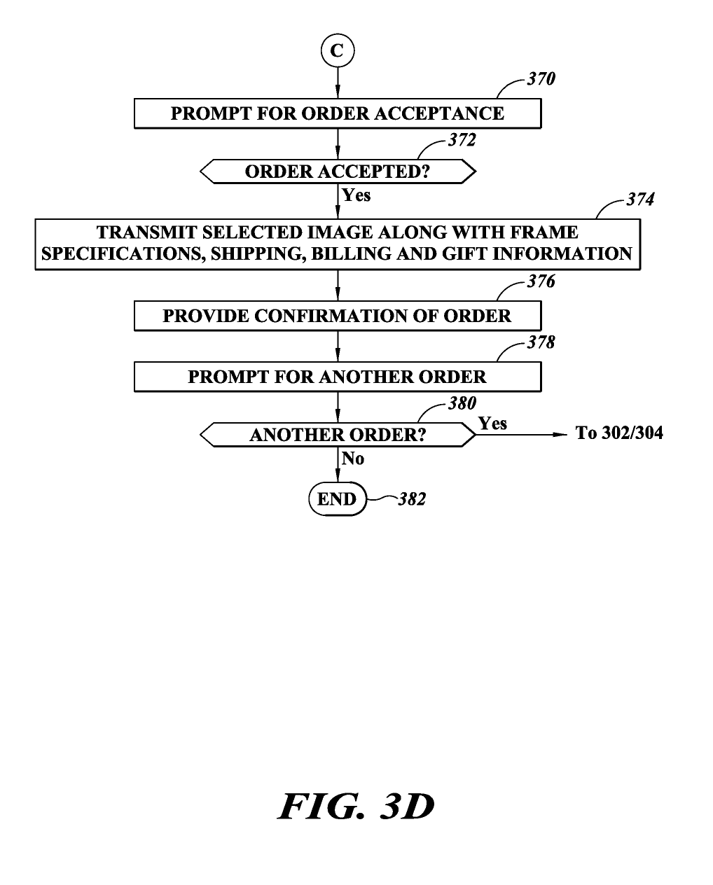

FIG. 3 shows a high level method 300 of operating a processor-based device to order custom framed prints of images in an order placement and fulfillment system, according to one illustrated embodiment. FIGS. 4A-4Z, 4AA, AB, 4AC show various exemplary screens or windows which may be displayed as part of executing the method 300. FIGS. 4A-4Z, 4AA, AB, 4AC are discussed in the context of the method 300 to enhance understanding.

Notably, the approach described herein limit the number of options provided to the user or consumer, to facilitate ordering of framed prints. In particular, the approaches limit the number of options presented per screen or window. In some implementations, the number of options is limited to 4 per screen or window. The approach may also employ a minimal number of screens, windows or steps in the ordering process. The approach is particularly useful where the size of a display is limited, such as is common of mobile devices.

The method 300 starts at 302. For example, the method 300 may start in response to an opening of a specific application or selection of an icon displayed on a display of a mobile device. In response, the processor-based display may cause a display or presentation of a splash screen, for instance a splash screen 400a such as that illustrated in FIG. 4A.

At 304, the processor-based device may provide a prompt for an image source to be selected, or may cause a prompt for an image source to be selected to be presented, for instance via a display of the mobile device. For example, the processor-based device may display or cause to be displayed an image source selection prompt screen 400b, identical or similar to that illustrated in FIG. 4B. The image source selection prompt screen 400b includes a take new photo user selectable icon 402a, selection of which passes control to a camera application executing on the mobile device. The image source selection prompt screen 400b includes a choose from library user selectable icon 402b, selection of which navigates to a library (e.g., Camera Roll) of images stored on the mobile device.

At 306, the processor-based device receives a selection indicative of a library or a new image as the image source. For example, the processor-based device may detect an input or selection of one of the user selectable icons 402a, 402b of the image source selection prompt screen 400b via a touchscreen display.

At 308, the processor-based device determines whether a library has been selected as the image source. If the library has been selected as the image source, at 310 the processor-based device may present a prompt for an existing image navigation tool, or may cause a prompt for an existing image navigation tool to be presented, for instance via a display of the mobile device. For example, the processor-based device may display or cause to be displayed an existing image navigation prompt screen 400c, identical or similar to that illustrated in FIG. 4C. The existing image navigation prompt screen 400c may include a library navigation user selectable icon 404a, selection of which allows the user to navigate through a Camera Roll or library of photos or other images. The existing image navigation prompt screen 400c may include a previous selections navigation user selectable icon 404b, selection of which allows the user to navigate through a collection of previously selected photos or other images. The previous selections navigation user selectable icon 404b may include a thumbnail visual representation of one or more previously selected images.

At 312, the processor-based device determines whether the user has selected an image from the library or from previously selected images. In response to selection of an image, at 314 the processor-based device retrieves or otherwise identifies the corresponding image file for the selected image for use. Control then passes to 324.

At 316, the processor-based device determines whether the user has selected a new image as the image source. If the user has selected to use a new image as the image source, at 318 the processor-based device may present a prompt to capture a new image, or may cause a prompt to capture a new image to be presented, for instance via a display of the mobile device. At 320, the processor-based device determines whether a new image has been captured using a camera of the mobile device. If a new image has been captured, at 322 the processor-based device retrieves or otherwise identifies the corresponding image file for the new image for use. Control then passes to 324.

At 324, the processor-based device prompts for a selection of orientation (e.g., square, portrait, landscape), or causes a prompt for a selection of orientation to be presented, for instance via a display of the mobile device. The processor-based device may, for example, present an orientation selection screen 400d, 400m, 400r, for instance identical or similar to that shown in FIGS. 4D, 4M and 4R, respectively. In particular, FIG. 4D shows an orientation selection screen 400d with a square orientation selected, FIG. 4M shows an orientation selection screen 400m with a landscape orientation selected, and FIG. 4R shows an orientation selection screen 400r with a portrait orientation selected.

The orientation selection screen 400d, 400m, 400r may include a large representation of the selected image 406a, 406b, 406c. The orientation selection screen 400d may include a number of user selectable orientation icons (e.g., square, landscape, portrait, square) 408a-408c (collectively 408), selection of which chooses a corresponding one of the orientations. The orientation selection screen 400d may include a price field 410, which is populated with an indication of price for the framed print. The amount displayed in the price field 410 may be based on the orientation, different orientations having different pricing. The amount may represent a lowest price for a framed print at the selected orientation. The currently selected orientation may be visually emphasized, for example by displaying the corresponding user selectable orientation icon 408 using a different color or with highlighting as compared to the other user selectable orientation icons, which is evident by comparison of FIGS. 4D, 4M and 4R.

At 326, the processor-based device receives an orientation selection. For example, the orientation selection screen 400d, 400m, 400r may include a scroll bar or set of scroll icons (not shown), selection of which causes incremental stepped movement either forward through the ordering process or backward in the ordering process, for instance stepping screen to screen. Movement forward in the ordering process indicates acceptance of the currently selected orientation.

At 328, the processor-based device prompts for selection of a frame type (e.g., wall mounted, desk/table mounted), or causes a prompt for a selection of a frame type to be presented, for instance via a display of the mobile device. Frame type selection may only be provided for certain orientation selections, for example being provided for portrait or landscape orientations but not for square orientations. The processor-based device may, for example, present a frame type selection screen 400n, 400s, 400x, 400aa, for instance identical or similar to that shown in FIGS. 4N, 4S, 4X and 4AA, respectively. The frame type selection screen 400n, 400s, 400x, 400aa may include a number of user selectable frame type selection icons (e.g., wall mounted, desk mounted) 412a, 412b, selection of which chooses a corresponding one of the frame types.

The frame type selection screen 400n, 400s, 400x, 400aa may include a large representation 414a, 414b, 414c, 414d respectively, of the selected image in the selected orientation, with a virtual visual representation of a frame of the currently selected frame type. The processor-based device updates the representation in response to toggling between selected frame types. Where desk type is selected, the virtual visual representation of the frame may be a perspective view, such that a leg 415 that extends from a rear of the frame to allow the frame to stand on flat surfaces is partially visible in the virtual visual representation. The frame type selection screen 400n, 400s may include a price field 410, which is populated with an indication of price for the framed print with the selected frame type and orientation. The amount may represent a lowest price for a framed print at the selected orientation and frame type. The currently selected frame type may be visually emphasized, for example by displaying the corresponding user selectable frame type icon 412a, 412b using a different color or with highlighting as compared to the other user selectable frame type icons 412a, 412b. Such is readily discernable by comparing FIGS. 4N, 4S, 4X and 4AA.

At 330, the processor-based device receives a frame type selection. For example, the frame type selection screen 400n, 400s may include a scroll bar or set of scroll icons (not shown), selection of which causes incremental stepped movement either forward through the ordering process or backward in the ordering process, for instance stepping screen to screen. Movement forward in the ordering process indicates acceptance of the currently selected frame type.

At 332, the processor-based device determines available sizes based on the selected orientation, frame type, and/or image characteristics of the selected image or new image. For example, square orientations will have sizes which have equal heights and widths, while landscape orientations will have widths that are greater than their heights, and portrait orientations will have heights greater than their widths. The processor-based device may employ defined ratios of height to width for the respective orientations, or may have a preset or defined set of frame sizes for each orientation. The processor-based device may be selected from the defined set to form a subset of frame sizes. The selection may be dependent on other parameters, for instance frame type and/or pixel density of the corresponding image file. Typically, the set of available dimensions for desk type frames will have sizes that are generally smaller that the sizes of the set of available dimensions for wall type frames. Typically, image files with higher densities of pixels (i.e., pixel densities) may allow larger prints to be printed while maintaining suitable resolution or granularity, allowing the use of larger dimension frames. Conversely, image files with relative low pixel densities may place a limit on the size of the larger print, causing the processor-based device to make available only frames of smaller dimensions.

At 334, the processor-based device prompts for a size selection from the determined available sizes, or causes a prompt for a selection of a size to be presented, for instance via a display of the mobile device. The size selection prompt may, for example, be in response to receipt of a frame type selection or a movement from screen to screen. The processor-based device may, for example, present a size selection screen 400e, 400o, 400t, 400y, 400ab, for instance identical or similar to that shown in FIGS. 4E, 4O 4T, 4Y and 4AB, respectively.

The size selection screens 400e, 400o, 400t, 400y, 400ab may include a number of user selectable size selection icons 416a-416r (collectively 416), selection of which chooses a corresponding one of the sizes. As an example, FIG. 4E shows a set of sizes for a square orientation and a given pixel density, the set including the sizes 5×5, 8×8, 10×10, 15×15, where sizes are given in inches. As another example, FIG. 4O shows a set of sizes for a landscape orientation wall style frame and a given pixel density, the set including the sizes 7×5, 10×8, 14×11, and 20×16, where sizes are given in inches width by height. As a further example, FIG. 4T shows a set of sizes for a landscape orientation for a desk style frame and a given pixel density, the set including the sizes 6×4, 7×5, and 10×8, where sizes are given in inches width by height. As another example, FIG. 4Y shows a set of sizes for a portrait orientation wall style frame and a given pixel density, the set including the sizes 5×7, 8×10, 11×14, and 16×20, where sizes are given in inches width by height. FIG. 4AB shows a set of sizes for a portrait orientation, desk style frame and a given pixel density, the set including the sizes 4×6, 5×7 and 8×10, where sizes are given in inches width by height.

In a similar fashion to the orientation selection screens 400d, 400m, 400r, the size selection screen 400e, 400o, 400t may include a large visual representation 414c, 414a, 414b, respectively, of the selected image in the selected orientation at the currently selected size. The processor-based device updates the representation in response to toggling between selected sizes.

The size selection screen 400e, 400o, 400t may include a price field 410, which is populated with an indication of price for the framed print with the selected frame type, orientation, and size. The amount may represent a lowest price for a framed print at the selected orientation, frame type, and size. The currently selected size may be visually emphasized, for example by displaying the corresponding user selectable size icon using a different color or with highlighting as compared to the other user selectable size icons. Such is readily discernable by comparing FIGS. 4E, 4O, and 4T.

At 336, the processor-based device receives a size selection. For example, the size selection screen 400n, 400s may include a scroll bar or set of scroll icons (not shown), selection of which causes incremental stepped movement either forward through the ordering process or backward in the ordering process, for instance stepping screen to screen. Movement forward in the ordering process indicates acceptance of the currently selected size.

At 338, the processor-based device prompts for a selection of frame color or other aesthetic treatment, or causes a prompt for a selection of a frame color to be presented, for instance via a display of the mobile device. The processor-based device may, for example, present a frame color selection screen 400f, 400p, 400u, 400z, 400ac, for instance identical or similar to that shown in FIGS. 4F, 4P, 4U, 4Z and 4AC, respectively. The frame color selection screen 400f, 400p, 400u, 400z, 400ac may include a number of user selectable frame color selection icons 418a-418d (collectively 418, e.g., black, grey, white, bronze), selection of which chooses a corresponding one of the frame colors.

The frame color selection screen 400f, 400p, 400u, 400z, 400ac may include a large representation 420a-420e, respectively, of the selected image 422a-422e in the selected orientation, with a virtual visual representation of a frame 424a-424e of the currently selected frame type, scaled dimensions, and color. The processor-based device updates the representation in response to toggling between selected frame colors.

The frame color selection screen 400f, 400p, 400u, 400z, 400ac may include a price field 410, which is populated with an indication of price for the framed print with the selected frame type, orientation, size, and color. The amount may represent a lowest price for a framed print at the selected orientation, frame type, size, and color. The currently selected frame color may be visually emphasized, for example by displaying the corresponding user selectable frame color icon using a different color or with highlighting as compared to the other user selectable frame color icons. Such is readily discernable by comparing FIGS. 4F, 4P, 4U, 4Z and 4AC.

At 340, the processor-based device receives a frame color selection. For example, the frame color selection screen 400f, 400p, 400u, 400z, 400ac may include a scroll bar or set of scroll icons (not shown), selection of which causes incremental stepped movement either forward through the ordering process or backward in the ordering process, for instance stepping screen to screen. Movement forward in the ordering process indicates acceptance of the currently selected frame color.

At 342, the processor-based device prompts for cropping and/or position adjustments to be made, if desired, or causes a prompt for cropping and/or position adjustments to be presented, for instance via a display of the mobile device. The processor-based device may, for example, present a cropping and positioning prompt screen 400g, 400v, for instance identical or similar to that shown in FIGS. 4G and 4V, respectively. The cropping and positioning screen 400g, 400v may include a virtual visual representation 426a, 426b, respectively, of the selected image 422d, 422e and the selected frame 424d, 424e, respectively. The cropping and positioning screen 400 may include an indication 426 of the currently selected frame dimensions, and an indication 428 of the dimensions of the print to be printed at a set of currently selected dimensions.

At 344, the processor-based device determines whether a user has selected to crop and/or adjust a position of the image. For example, a legend or notice 430 may indicate to the user that a tap or double tap input may be used to enter a cropping and positioning mode.

In response, the processor-based device may present or cause to be presented a cropping and positioning screen 400ad, which may be identical or similar to that shown in FIG. 4W. In the cropping and positioning mode, the selected image 424e is adjustable in size and position with respect to a border 428 and a grid that serves as a visual representation of the position of the print in the selected frame. The grid may include vertical guidelines 430 and horizontal guidelines 432 (only one of each called out) to allow a user to visually assess changes in size, cropping and/or position of the selected image 424e with respect to the visual representation of the border 428. The relative size of the selected image 424e may be adjusted, for example, via two finger pinching type inputs, drawing the forefinger and thumb together to reduce the size, or spreading the forefinger and thumb apart to increase the size. The size may optionally adjust or scale according to the selected dimensions (e.g., 10×12). The relative position of the selected image 424e may be adjusted, for example, via one finger dragging (i.e., touch and swipe) motions. The mobile device updates the visual representation 424e in real time, as well as updating the dimensions 428 (FIG. 4V) of the print to be printed.

The cropping and positioning prompt screen 400g, 400v may include a price field 410, which is populated with an indication of price for the framed print with the selected frame type and orientation. The amount may represent a lowest price for a framed print at the selected orientation, frame type, frame size, and color.

At 346, the processor-based device determines whether the cropping and/or position adjustments are complete. For example, the cropping and positioning prompt screen 400g, 400v may include a scroll bar or set of scroll icons (not shown), selection of which causes incremental stepped movement either forward through the ordering process or backward in the ordering process, for instance stepping screen to screen. Movement forward in the ordering process indicates acceptance of the currently selected cropped and positioned image.

At 348, the processor-based device presents initial order summary information, or causes order summary information to be presented, for instance via a display of the mobile device. The processor-based device may, for example, present an initial order summary information screen 400h, 400q, for instance identical or similar to that shown in FIGS. 4H and 4Q. The initial order summary information screen 400h, 400q may present a virtual visual representation 434a, 434b, respectively, of the selected image and selected frame. The initial order summary information screen 400h, 400q may present specific information 436a, 436b about the print of the selected image (e.g., dimensions of print) and specific information 438a, 438b about the selected frame (e.g., dimensions of frame, color of frame).

The initial order summary information screen 400h, 400q may include pricing information including a price of the print and the frame 440a, 440b, and a cost of shipping 442a, 442b, as well as a sum total amount 444a, 444b.

The initial order summary information screen 400h, 400q may include a user selectable order icon 446a, selection of which indicates a desire to place an order for the selected print and frame. The initial order summary information screen 400h, 400q may include a user selectable save for later icon 446b, selection of which indicates a desire to save the selected print and frame for ordering at another time.

At 350, the processor-based device prompts for shipping information, or causes a prompt for shipping information to be presented, for instance via a display of the mobile device. The processor-based device may, for example, present a shipping information entry screen 400i, 400j, 400k, for instance identical or similar to that shown in FIG. 4I (fields unpopulated), 4J (fields populated) or 4K. The shipping information entry screen 400i, 400j, 400k may include a variety of fields which are populatable with shipping related information. For example, a ship to name field 450 may be populated with the name of a person or other entity to which the framed print will be shipped. Shipping address fields 452a, 452b may be populated with a street address of the person or other entity to which the framed print will be shipped. A city field 454 may be populated with the name of a city to which the framed print will be shipped. A state field 456 may be populated with the name of a state or province to which the framed print will be shipped. A zip code field 458 may be populated with postal service designation assigned to a geographic location to which the framed print will be shipped.

At 352, the processor-based device receives shipping information, for example via the shipping information entry screen 400. At 354, the processor-based device determines whether the received shipping information is complete and/or accurate. For example, the processor-based device may determine if a number of necessary fields 450-458 contain information and/or may verify information contained in those fields 450-458. For instance, the processor-based device may verify that a specified zip code is correct for a given state and city. If the shipping information appears to be incomplete or inaccurate, at 356 the processor-based device prompts for completion shipping information, or causes a prompt to complete the shipping information to be presented, for instance via a display of the mobile device. The prompt may provide an indication of fields 450-458 that are incomplete or inaccurate, for instance fields which are necessary for shipment (e.g., recipient's name, recipient's address, recipient's telephone or electronic mail address) and which are as yet incomplete.

At 358, the processor-based device prompts for billing information or causes a prompt for billing information to be presented, for instance via a display of the mobile device. For example, the shipping information entry screen 400i, 400j, 400k may also include a checkbox or field 460 to indicate whether the shipping and billing addresses are the same. The shipping information entry screen 400i, 400j, 400k may also include a billing name field 462 and one or more billing address fields 464 to enter billing name and billing address respectively, particularly where the billing information differs from the shipping information. Where the billing information matches the shipping information, the processor-based device may automatically populate the billing name and billing address fields in response to checking the appropriate checkbox. At 360, the processor-based device determines whether the billing information is complete or accurate. If the billing information appears to be incomplete or inaccurate, at 362 the processor-based device prompts for completion of the billing information, or causes a prompt to complete the billing information to be presented, for instance via a display of the mobile device. The prompt may provide an indication of fields 460, 462 that are incomplete or inaccurate, for instance fields 460, 462, which are necessary for billing (e.g., name, account number, validation code, address associated with payment account) and which are as yet incomplete.

At 364, the processor-based device prompts for gift information. For example, the shipping information entry screen 400 may also include a checkbox or field 464 to indicate whether the framed print will be a gift. If checked, a message field 466 may be displayed, allowing the user to add a message from the sender to the recipient of the gift. The sender may wish to populate the message field 466 with a message acknowledging a special event or achievement. In some instances, the shipping information entry screen 400i, 400j, 400k may also include an email address field 468 (FIG. 4K) to specify an electronic mail (i.e., email) address, for example for the recipient and/or sender. At 366, the processor-based device determines whether the gift information is complete. At 368, the processor-based device prompts to complete gift information, or causes a prompt for gift information to be presented, for instance via a display of the mobile device. Gift information may, for example, include a message from a sender to a recipient, such as an acknowledgement of a special event or achievement.

At 370, the processor-based device prompts for order acceptance or causes a prompt for order acceptance to be presented, for instance via a display of the mobile device. The processor-based device may, for example, present a final order summary information screen 400l, for instance identical or similar to that shown in FIG. 4L. The final order summary information screen 400l may present a virtual visual representation 470 of the selected image and selected frame, along with specific information about the selected frame 472 (e.g., dimensions of frame, color of frame), along with the current date 474.

The final order summary information screen 400l may include user selectable icons 474a, 474b to increment and/or decrement a quantity 476 of framed prints being ordered.

The final order summary information screen 400l may include pricing information including a price of the print and the frame 478, and a cost of shipping 480, amount of tax 482, as well as a sum total amount 484. The final order summary information screen 400l may include an indication 486 of the identity of the entity to which the order will be shipped.

At 372, the processor-based device determines whether the order has been accepted. For example, the final order summary information screen 400l may include a scroll bar or set of scroll icons (not shown), selection of which causes incremental stepped movement either forward through the ordering process or backward in the ordering process, for instance stepping screen to screen. Movement forward in the ordering process indicates acceptance of the order by the user or consumer.

At 374, the processor-based device transmits or otherwise registers an order for a framed print of an image. For example, the processor-based device may send a message to a server or back-office system, the message including image data or file, framing specifications (e.g., size, orientation, frame type, frame color), and/or mat selection.

At 376, the processor-based device provides confirmation of order or causes an order confirmation to be presented, for instance via a display of the mobile device.

At 378, the processor-based device prompts for another or a new order, or causes a prompt for another or a new order to be presented, for instance via a display of the mobile device. The prompt inquires whether the user desires to assemble another or a new order for a framed print of an image. At 380, the processor-based device determines whether the user has selected to assemble another or a new order. If the user has selected to assemble another or a new order, control returns to 304. If the user has selected to not assemble another or a new order, control may pass to 382.

At 382, the processor-based device ends the method 300. The method 300 terminates at 382 until called again. Alternatively, the method 300 may repeat, for example, with control returning to 302. Alternatively, the method 300 may run concurrently with other methods or processes, for example, as one of multiple threads on a multi-threaded processor system.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operation in a processor-based system, the method comprising:
receiving an orientation selection by at least one processor, the orientation selection which corresponds to a choice of a respective orientation for a tangible frame to be ordered;
receiving a frame type selection by at least one processor, the frame type selection which corresponds to a choice of a type of the tangible frame to be ordered;
determining a set of selectable sizes of the tangible frame to be ordered by at least one processor, the determination based at least in part on the orientation selection and the frame type selection;
providing a set of size options corresponding to the determined set of selectable sizes, by at least one processor, the selection of which corresponds to a choice of a respective size for the tangible frame to be ordered; and
generating a virtual representation of the tangible frame with a selected image framed thereby by at least one processor.

2. The method of claim 1, further comprising:
receiving an image selection by at least one processor, the image selection indicative of a selection of the selected image before determining the set of selectable sizes of the tangible frame to be ordered.

3. The method of claim 2 wherein determining a set of selectable sizes of the tangible frame to be ordered based at least in part on the orientation selection and the frame type selection includes determining the set of selectable sizes of the tangible frame to be ordered based at least in part on the orientation selection the frame type selection, and a set of image information that specifies one or more characteristics of an image file that stores a representation of the selected image.

4. The method of claim 1 wherein the selected image is a picture, and the one or more characteristics include a pixel density of an image file which represents the selected image.

5. The method of claim 3, further comprising:
providing a set of user selectable size icons based on the determined set of selectable sizes of the tangible frame to be ordered.

6. The method of claim 1 wherein the providing the set of user selectable size icons is in response to receiving the frame type selection.

7. The method of claim 1, further comprising:
providing a set of user selectable orientation icons via at least one user input/output device, selection of which corresponds to the choice of the respective orientation for the tangible frame; and
providing a set of user selectable frame type icons, selection of which corresponds to the choice of a type of tangible frame.

8. The method of claim 7 wherein providing a set of user selectable orientation icons via at least one user input/output device includes providing a portrait icon which corresponds to the choice of a portrait orientation for the tangible frame; and providing a landscape icon which corresponds to the choice of a landscape orientation for the tangible frame.

9. The method of claim 8 wherein providing a set of user selectable orientation icons via at least one user input/output device further includes providing a square icon which corresponds to the choice of a square orientation for the tangible frame.

10. The method of claim 7 wherein providing a set of user selectable frame type icons, selection of which corresponds to the choice of a type of tangible frame includes providing a wall frame icon which corresponds to a wall mounted tangible frame and a desk frame icon that corresponds to a desk mounted tangible frame.

11. The method of claim 1, further comprising:
receiving a frame color selection by at least one processor, the frame color selection which corresponds to a choice of a respective frame color for the tangible frame to be ordered.

12. The method of claim 11, further comprising:
providing a set of user selectable frame color icons, selection of which corresponds to a choice of a respective frame color of the tangible frame to be ordered.

13. The method of claim 1, further comprising:
receiving a mat selection by at least one processor, the mat selection which corresponds to a choice of a respective mat option for the tangible frame to be ordered.

14. The method of claim 13, further comprising:
providing a set of user selectable mat option icons, selection of which corresponds to a choice of a respective mat option for the tangible frame to be ordered.

15. The method of claim 1, further comprising:
determining based on the received frame type selection whether to provide a set of user selectable mat option icons by at least one processor, selection of which corresponds to a choice of a respective mat option for the tangible frame to be ordered.

16. The method of claim 1, further comprising:
receiving shipping information by at least one processor;
receiving billing information by at least one processor;
receiving gift information if a gift option is selected, the gift information including a gift message; and
generating an order for the tangible frame.

17. The method of claim 1 wherein generating a virtual representation of the tangible frame with a selected image framed thereby includes generating a virtual perspective image in which a leg of the tangible frame is visible if the frame type selection corresponds to the desk mounted tangible frame and with a mat if a mat selection corresponds to include a mat.

18. The method of claim 1 wherein receiving an orientation selection, receiving a frame type selection, determining a set of selectable sizes of the tangible frame to be ordered, providing a set of size options, and generating a virtual representation of the tangible frame with a selected image framed thereby are each performed by at least one processor of a mobile communications device having at least one image sensor to capture images and at least one non-transitory processor-readable medium communicatively coupled to the at least one processor and the at least one image sensor.

19. A processor-based system, comprising:
at least one processor; and
at least one nontransitory processor-readable medium, communicatively coupled to the at least one processor and which stores at least one of processor-executable instructions or data, wherein in use the at least one processor:
receives an orientation selection, the orientation selection which corresponds to a choice of a respective orientation for a tangible frame to be ordered;
receives a frame type selection, the frame type selection which corresponds to a choice of a type of the tangible frame to be ordered;
determines a set of selectable sizes of the tangible frame to be ordered by at least one processor, the determination based at least in part on the orientation selection and the frame type selection;
causes provision of a set of size options corresponding to the determined set of selectable sizes, the selection of which corresponds to a choice of a respective size for the tangible frame to be ordered; and
generates a virtual representation of the tangible frame with a selected image framed thereby.

20.-34. (canceled)

35. The processor-based system of claim 19 wherein to generate a virtual representation of the tangible frame with a selected image framed thereby the at least one processor:
generates a virtual perspective image in which a leg of the tangible frame is visible if the frame type selection corresponds to the desk mounted tangible frame and with a mat if a mat selection corresponds to include a mat.

36. (canceled)

37. A method of operation in a processor-based system, the method comprising:
receiving an image selection by at least one processor, the image selection indicative of a selection an image to be framed in a tangible frame;
determining a subset of framing options from a plurality set of framing options by at least one processor, based at least in part on a set of image information that specifies one or more characteristics of an image file that stores a representation of the selected image;
causing the determined subset of framing options to be presented;
receiving by at least one processor at least one selection that corresponds to at least one of the presented framing options; and
generating by at least one processor a virtual representation of the tangible frame based on the received at least one selection with the selected image framed thereby.

38.-70. (canceled)
